(19) United States
(12) Patent Application Publication
(10) Pub. No.: US 2026/0270894 A1
(43) Pub. Date: Sep. 10, 2026

(54) METHODS, ARCHITECTURES, APPARATUSES AND SYSTEMS FOR COORDINATED SPATIAL REUSE TRANSMISSIONS

(71) Applicant: InterDigital Patent Holdings, Inc., Wilmington, DE (US)

(72) Inventors: Ying Wang, Easton, PA (US); Rui Yang, Greenlawn, NY (US); Hanqing Lou, Syosset, NY (US); Xiaofei Wang, North Caldwell, NJ (US); Mahmoud Saad, L’Ile Bizard (CA); Joseph Levy, Merrick, NY (US)

(21) Appl. No.: 19/073,693

(22) Filed: Mar. 7, 2025

(51) Int. Cl. H04W 52/38; H04W 52/24

(52) U.S. Cl. CPC H04W 52/386; H04W 52/241; H04W 52/245

(57) ABSTRACT

Methods, architectures, apparatuses, and systems directed to coordinated spatial reuse are described herein. In an embodiment, a first access point (AP) may be configured to transmit a first transmission and to transmit to a first station (STA) associated with the first AP, a first frame that may request received power measurement information. The first AP may be configured to receive from the first STA a second frame including the requested received power measurement information. The first AP may be configured to transmit, to the second AP, a trigger frame including a second AP identifier and a first indication of first transmit power adjustment information for the second AP. The first AP may be configured to transmit to the first STA a third transmission that may share a same set of resources as the second AP used for a fourth transmission.

### TECHNICAL FIELD

The present disclosure is generally directed to the fields of communications, software and encoding, including methods, architectures, apparatuses, and systems directed to coordinated spatial reuse transmissions.

### BACKGROUND

A wireless local area network (WLAN) in infrastructure basic service set (BSS) mode has an access point (AP) for the BSS and one or more stations (STAs) associated with the AP. The AP may have access or interface to a distribution system (DS) or another type of wired/wireless network carrying traffic in and out of the BSS. Embodiments described herein have been designed with the foregoing in mind.

### SUMMARY

Methods, architectures, apparatuses, and systems directed to coordinated spatial reuse transmission are described herein. In an embodiment, a first AP may include circuitry including a transmitter, a receiver, a processor, and memory. The first AP may be configured to transmit a first transmission (e.g., to be used for measurement). The first AP may be configured to transmit to a first station (STA) associated with the first AP, a first frame that may request received power measurement information. The first AP may be configured to receive from the first STA a second frame including the requested received power measurement information. In various embodiments, the requested received power measurement information may indicate: (i) first received power measurement information associated with the first transmission measured at the first STA, and (ii) second received power measurement information associated with a second transmission received from a second AP and measured at the first STA, the first STA not being associated with the second AP. The first AP may be configured to transmit, to the second AP, a trigger frame including a second AP identifier and a first indication of first transmit power adjustment information for the second AP based on the indicated first and second received power measurement information. In various embodiments, the second AP identifier may identify the second AP. The first AP may be configured to transmit to the first STA a third transmission that may share a same set of resources as the second AP used for a fourth transmission. In various embodiments, the first AP transmitting the third transmission over the same set of resources as the second AP used for the fourth transmission may be based on the first transmit power adjustment information for the second AP.

In an embodiment, a first method implemented in a first AP may include transmitting a first transmission (e.g., to be used for measurement). The first method may include transmitting to a first station (STA) associated with the first AP, a first frame that may request received power measurement information. The first method may include receiving from the first STA a second frame including the requested received power measurement information. In various embodiments, the requested received power measurement information may indicate: (i) first received power measurement information associated with the first transmission measured at the first STA, and (ii) second received power measurement information associated with a second transmission received from a second AP and measured at the first STA, the first STA not being associated with the second AP. The first method may include transmitting to the second AP, a trigger frame including a second AP identifier and a first indication of first transmit power adjustment information for the second AP based on the indicated first and second received power measurement information. In various embodiments, the second AP identifier may identify the second AP. The first method may include transmitting to the first STA a third transmission that may share a same set of resources as the second AP used for a fourth transmission. In various embodiments, the first AP transmitting the third transmission over the same set of resources as the second AP used for the fourth transmission may be based on the first transmit power adjustment information for the second AP.

In an embodiment, a second AP may include circuitry including a transmitter, a receiver, a processor, and memory. The second AP may be configured to transmit a first transmission (e.g., to be used for measurement). The second AP may be configured to receive from a first AP a trigger frame indicating a second AP identifier and an indication of transmit power adjustment information for the second AP. In various embodiments, the indication of transmit power adjustment information may be based on the first transmission. In various embodiments, the second AP identifier may identify the second AP. The second AP may be configured to transmit to a STA associated with the second AP, a fourth transmission that may share a same set of resources as the first AP used for a third transmission. In various embodiments, the second AP transmitting the fourth transmission over the same set of resources as the first AP used for the third transmission may be based on the transmit power adjustment information for the second AP.

In an embodiment, a second method implemented in a second AP may include transmitting a first transmission (e.g., to be used for measurement). The second method may include receiving from a first AP a trigger frame indicating a second AP identifier and an indication of transmit power adjustment information for the second AP. In various embodiments, the indication of transmit power adjustment information may be based on the first transmission. In various embodiments, the second AP identifier may identify the second AP. The second method may include the second AP transmitting to a STA associated with the second AP, a fourth transmission that may share a same set of resources as the first AP used for a third transmission. In various embodiments, the second AP transmitting the fourth transmission over the same set of resources as the first AP used for the third transmission may be based on the transmit power adjustment information for the second AP.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2A is a diagram illustrating a transmission opportunity (TXOP) level Co-SR transmission scheme;

FIG. 2B is a diagram illustrating the signal and interference paths between two concurrent Co-SR downlink transmission pairs;

FIG. 3 is a diagram illustrating an example of Co-SR protocol;

FIG. 4 is diagram illustrating an example process in the measurement phase;

FIG. 5 is diagram illustrating an example process in the reporting phase;

FIG. 6 is a diagram illustrating an example TXOP level multi access point (MAP) information exchange and coordination;

FIG. 7 is a diagram illustrating an example of Co-SR with power control;

FIG. 8 is a diagram illustrating an example trigger frame format;

FIG. 9 is a diagram illustrating an example ultra-high reliability (UHR) variant Common Info field;

FIG. 10 is a diagram illustrating an example Special User Info field format;

FIG. 11 is a diagram illustrating a first UHR variant User Info field format for Co-SR transmissions;

FIG. 12 is a diagram illustrating a second UHR variant User Info field format for Co-SR transmissions;

FIG. 13 is a diagram illustrating an example method for coordinated spatial reuse transmissions, implemented in a first AP; and

FIG. 14 is a diagram illustrating an example method for coordinated spatial reuse transmissions, implemented in a second AP.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

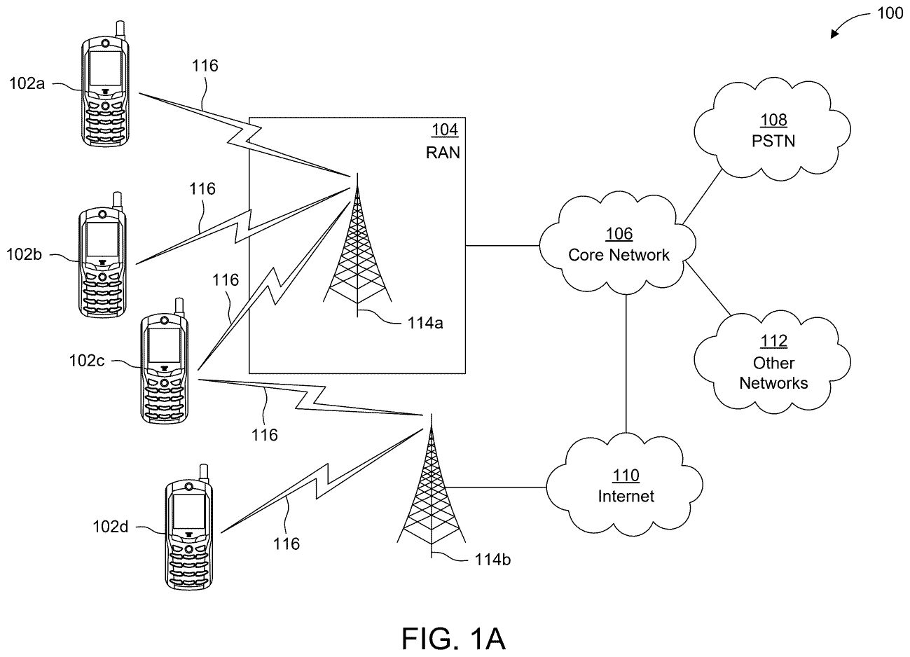

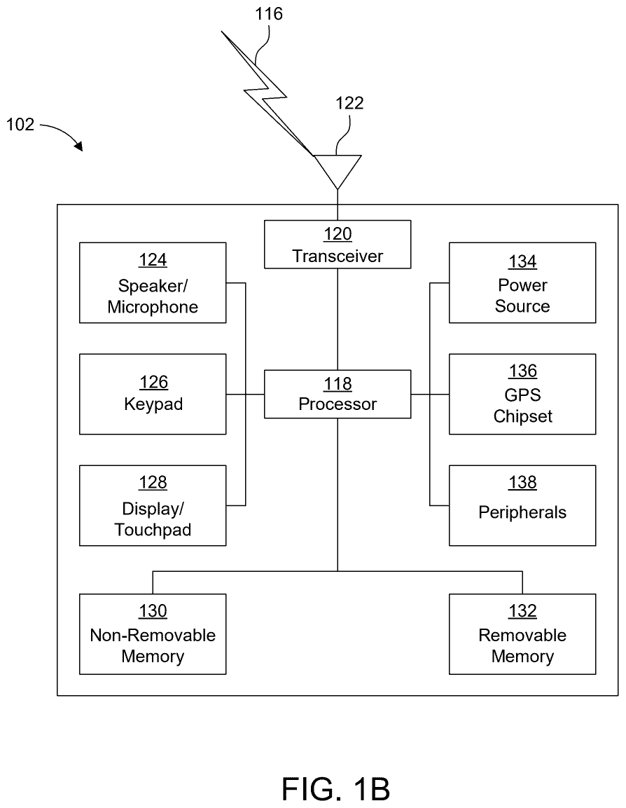

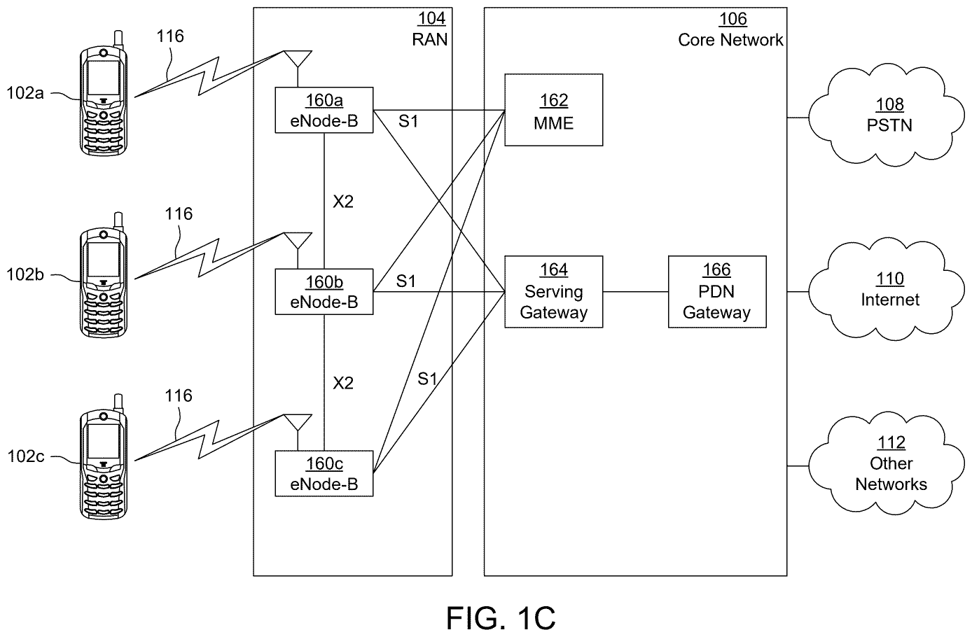

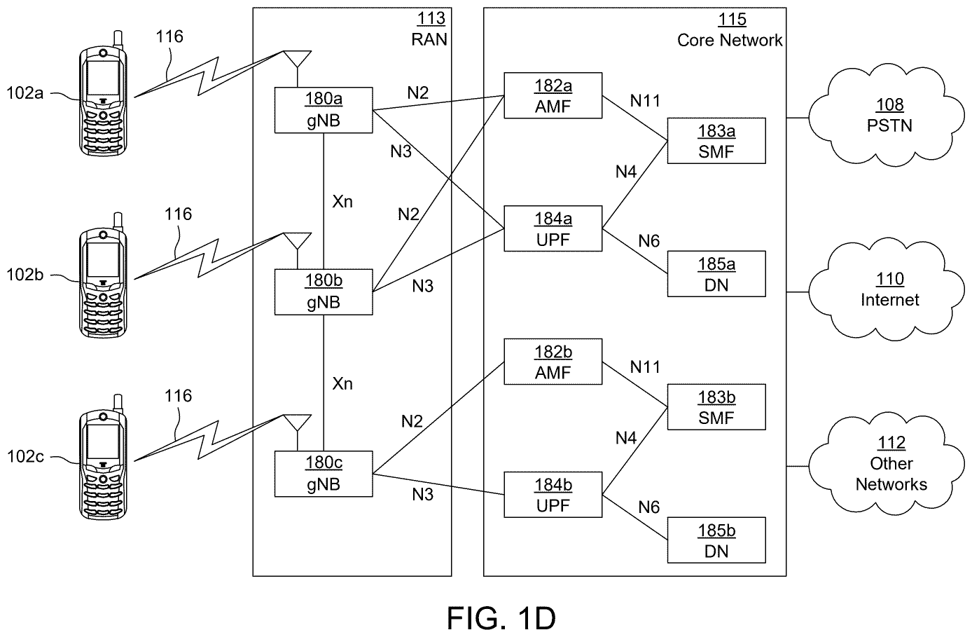

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as Institute of electrical and electronics engineers (IEEE) 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, carrier sense multiple access with collision avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (e.g., contiguous, or non-contiguous), one or more subchannels within a channel, one or more resource units (RUs) within an orthogonal frequency division multiple access (OFDMA) system, whereby assigned one or more RUs may be adjacent (e.g., contiguous) or non-contiguous, occupying one or more channels or subchannels, etc.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the medium access control (MAC) layer, entity, etc.

High Efficiency Wireless (HEW or 802.11ax) STAs may support 20 MHz, 40 MHz, 80 MHz, and/or 160 MHz wide channels capable of transmission over 2.4 GHz, 5 GHz, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., ultra-high reliability—UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by an AP/STA from the network, for example, through system information or via any kind of protocol message. Although not explicitly mentioned throughout embodiments described herein, the same (e.g., configuration) information may be pre-configured in the AP/STA (e.g., via any kind of pre-configuration methods such as e.g., via factory settings), such that this (e.g., configuration) information may be used by the AP/STA without being received from the network.

Throughout embodiments described herein, the expression “the AP/STA may be configured with a set of parameters” is equivalent or may be used interchangeably with “the AP/STA may receive configuration information (e.g., from another network element) indicating a set of parameters”. Throughout embodiments described herein, the expressions “the AP/STA may report something”, and “the AP/STA may be configured to report something”, is equivalent or may be used interchangeably with “the AP/STA may transmit (e.g., reporting) information indicating something”. Throughout embodiments described herein, the expression “the AP/STA may provide (/be provided) with a set of parameters (/something)” is equivalent or may be used interchangeably with “the AP/STA may transmit (/receive) information indicating a set of parameters (/something)”.

In embodiments described herein, “a” and “an” and similar phrases are to be interpreted as “one or more” and “at least one”. Similarly, any term which ends with the suffix “(s)” is to be interpreted as “one or more” and “at least one”. The term “may” is to be interpreted as “may, for example”.

A symbol “/” (e.g., forward slash) may be used herein to represent “and/or”, where for example, “A/B” may imply “A and/or B”.

In embodiments described herein, “list of”, “set of” and “one or more of” may be used interchangeably.

In embodiments described herein, “identity” and “identifier” may be used interchangeably to refer to how a network element (or an AP/STA) may be identified.

In embodiments described herein, a STA may refer to any of an AP STA and a non-AP STA. The architecture depicted at FIG. 1B for a WTRU 102 may be applicable more generally to any of an AP STA and a non-AP.

In embodiments described herein, the terms “AP” and “AP STA” may be used interchangeably.

In embodiments described herein, the terms “frame” and “transmission” may be used interchangeably.

In embodiments described herein, a transmission opportunity (TXOP) may refer to an interval of time during which a particular (e.g., quality-of-service (QoS)) STA may (e.g., have the right to) initiate frame exchange sequences onto the wireless medium (WM).

In embodiments described herein, spatial reuse (SR) refers to the transmission of a physical layer protocol data unit (PPDU) on the medium under certain conditions when another PPDU has been detected that would otherwise have prevented the transmission.

In embodiments described herein, a trigger based physical layer protocol data unit (TB PPDU) may refer to a PPDU transmitted with any of high efficiency (HE) TB PPDU (HE TB PPDU) format or extremely high throughput (EHT) TB PPDU (EHT TB PPDU) format.

In embodiments described herein, an overlapping basic service set (OBSS) may refer to a basic service set (BSS) operating on the same channel as the station's BSS and within (partly or wholly) its basic service area (BSA).

In embodiments described herein, a basic service set (BSS) color (BSS color) may refer to an identifier for a BSS or for a set of BSSs belonging to a multiple basic service set identifier (BSSID) set or a co-hosted BSSID set.

For the sake of clarity, embodiments are described herein with 20 MHz as an example of subchannel. Embodiments described herein are not limited to 20 MHz subchannels and may be applicable to subchannels of any size of the PPDU bandwidth (e.g., 40 MHz or any other size).

A WLAN in infrastructure basic service set (BSS) mode has an access point (AP) for the BSS and one or more stations (STAs) associated with the AP. The AP may have access or interface to a distribution system (DS) or another type of wired/wireless network carrying traffic in and out of the BSS. Traffic to STAs originating from outside the BSS may arrive through the AP and may be delivered to the STAs. Traffic originating from STAs to destinations outside the BSS may be sent to the AP to be delivered to the respective destinations. Traffic between STAs within the BSS may (e.g., also) be sent through the AP where the source STA may send traffic to the AP and the AP may deliver the traffic to the destination STA. Traffic between STAs within a BSS may be referred to as peer-to-peer traffic. Such peer-to-peer traffic may (e.g., also) be sent directly between the source and destination STAs with a direct link setup (DLS) using an IEEE 802.11e DLS or an IEEE 802.11z tunneled DLS (TDLS). A WLAN using independent BSS (IBSS) mode has no AP, and the STAs using such IBSS may communicate directly with each other. This mode of communication may be referred to as an “ad-hoc” mode of communication.

Using the IEEE 802.11ac infrastructure mode of operation, the AP may transmit a beacon on a fixed channel, e.g., the primary channel. This channel may be 20 MHz wide and may be the operating channel of the BSS. This channel may be used by the STAs to establish a connection with the AP. The channel access mechanism in an IEEE 802.11 system is based on carrier sense multiple access with collision avoidance (CSMA/CA). In this mode of operation, a (e.g., every) STA, including the AP, may sense occupancy or vacancy of the primary channel. If the channel is detected to be busy, the STA may back off. Hence only one STA may transmit at any given time, frequency and space resource in a (e.g., each) BSS.

In IEEE 802.11n (described in IEEE Std 802.11™-2020), high throughput (HT) STAs may also use a 40 MHz wide channel for communication. This is achieved by combining the primary 20 MHz channel, with an adjacent 20 MHz channel to form a 40 MHz wide contiguous channel.

In IEEE 802.11ac (described in IEEE P802.11ax/D8.0), very high throughput (VHT) STAs may support 20 MHz, 40 MHz, 80 MHz, and 160 MHz wide channels. The 40 MHz, and 80 MHz, channels may be formed by combining contiguous 20 MHz channels as described herein for IEEE 802.11n. A 160 MHz channel may be formed by combining eight contiguous 20 MHz channels, or by combining two non-contiguous 80 MHz channels, which may also be referred to as an 80+80 configuration. For the 80+80 configuration, at the transmitter, the data, after channel encoding, may be passed through a segment parser that may divide the data into two streams. Inverse fast Fourier transform (IFFT) and time domain processing may be done on a (e.g., each) stream separately. The two streams may be mapped onto the two 80 MHz channels for transmission. At the receiver, this mechanism is reversed, and the combined data from the two 80 MHz channels may be sent to the MAC layer.

In IEEE 802.11ax (described in IEEE P802.11ax/D8.0), high efficiency (HE) wireless STAs may support any of 20 MHz, 40 MHz, 80 MHz, and 160 MHz wide channels capable of transmission over any of 2.4 GHz, 5 GHz, and 6 GHz frequency bands using (e.g., both) orthogonal frequency-division multiple access (OFDMA) and multi-user multiple-input multiple-output (MU-MIMO) capabilities. OFDMA subcarrier modulation in HE STAs may include formats such as any of BPSK, QPSK, 16-QAM, 64-QAM, 256-QAM, and 1024-QAM. The evolution of IEEE 802.11 to extremely high throughput (EHT, or IEEE 802.11be) STAs may extend to having 320 MHz wide channels.

Sub 1 GHz modes of operation are supported by IEEE 802.11af, and IEEE 802.11ah. For these specifications the channel operating bandwidths, and the number of orthogonal frequency-division multiplexing (OFDM) subcarriers, are reduced relative to those used in IEEE 802.11n, and IEEE 802.11ac. IEEE 802.11af supports 5 MHz, 10 MHz and 20 MHz bandwidths in the television (TV) white space (TVWS) spectrum, and IEEE 802.11ah supports 1 MHz, 2 MHz, 4 MHz, 8 MHz, and 16 MHz bandwidths using non-TVWS spectrum. An example of use case for IEEE 802.11ah may include support for meter type control (MTC) devices in a macro coverage area. MTC devices may have limited capabilities with limited bandwidths and may require a very long battery life.

WLAN systems that may support multiple channels, and channel widths, such as IEEE 802.11n, IEEE 802.11ac, IEEE 802.11af, 802.11ah, 802.11ax, and IEEE 802.11be, may include a channel that may be referred to as the primary channel. The primary channel may have, for example, a bandwidth equal to the largest common operating bandwidth supported by (e.g., all) STAs in the BSS. The bandwidth of the primary channel may be limited by the STA that may support the smallest bandwidth operating mode in the BSS. In the example of IEEE 802.11ah, the primary channel may be 1 MHz wide if there are STAs (e.g. MTC type devices) that (e.g., only) support a 1 MHz mode (e.g., even) if the AP, and other STAs in the BSS, may support any of 2 MHz, 4 MHz, 8 MHz, 16 MHz, or other channel bandwidth operating modes. In an example, (e.g., all) carrier sensing, and NAV settings, may depend on the status of the primary channel; e.g., if the primary channel is busy, for example, due to a STA supporting (e.g., only) a 1 MHz operating mode being transmitting to the AP, then the (e.g., entire) available frequency bands may be considered busy e.g., even though majority of it stays idle and available.

The ultra-high reliability (UHR) study group is described herein.

The IEEE 802.11 ultra-high reliability (UHR), also known as IEEE 802.11bn, study group was formed in September 2022. UHR is considered as the next major revision to IEEE 802.11 standards following 802.11be (or EHT), which is currently in the working group letter ballot stage. UHR may explore the possibility to improve reliability, support further reduced low latency traffic, further increase peak throughput, improve power saving capabilities, and improve efficiency of the IEEE 802.11 network over EHT.

Coordinated spatial reuse (Co-Sr) is described herein.

IEEE 802.11bn defines multi-AP coordinated spatial reuse (Co-SR) at TXOP-level with power control. IEEE 802.11bn may allow more efficient medium usage by concurrent transmissions of multiple APs using transmit power control. The Co-SR transmission may be initiated by an AP that may obtain a TXOP and may become the initiating AP (which may be referred to herein as sharing AP). The sharing AP may transmit a trigger frame to the participating AP (which may be referred to herein as shared AP) identified by the AP ID carried, for example, in the AID12 field of the user info field of the trigger frame to initiate the concurrent Co-SR transmission, as described in IEEE P802.11bn™/D0.1. IEEE 802.11bn limits the concurrent Co-SR transmission to the sharing AP and (e.g., only) one shared AP. A short interval after the trigger frame, the two APs may (e.g., simultaneously start to) transmit their respective data PPDUs during the concurrent Co-SR transmission. The duration of the two ensuing data PPDUs may be the same. In addition, IEEE 802.11bn limits both data PPDUs to be downlink (DL) single-user (SU) PPDUs and the maximum number of spatial streams transmitted by each AP in Co-SR to four. Moreover, IEEE 802.11bn defines two modes for the concurrent Co-SR transmission. In a first mode (referred to herein as Mode 1), at least one of the two data PPDUs during the concurrent Co-SR transmission may be an EHT PPDU. The format of the two data PPDUs may be a combination of UHR+EHT, EHT+UHR, or EHT+EHT. Both PPDUs may have the same L-SIG (non-high-throughput signal field) content. In a second mode (referred to as Mode 2), both data PPDUs may be UHR PPDUs that may have the same L-SIG and U-SIG contents. In Mode 2, the short interval between the end of the trigger frame and the two concurrent UHR data PPDUs may be a short interframe space (SIFS).

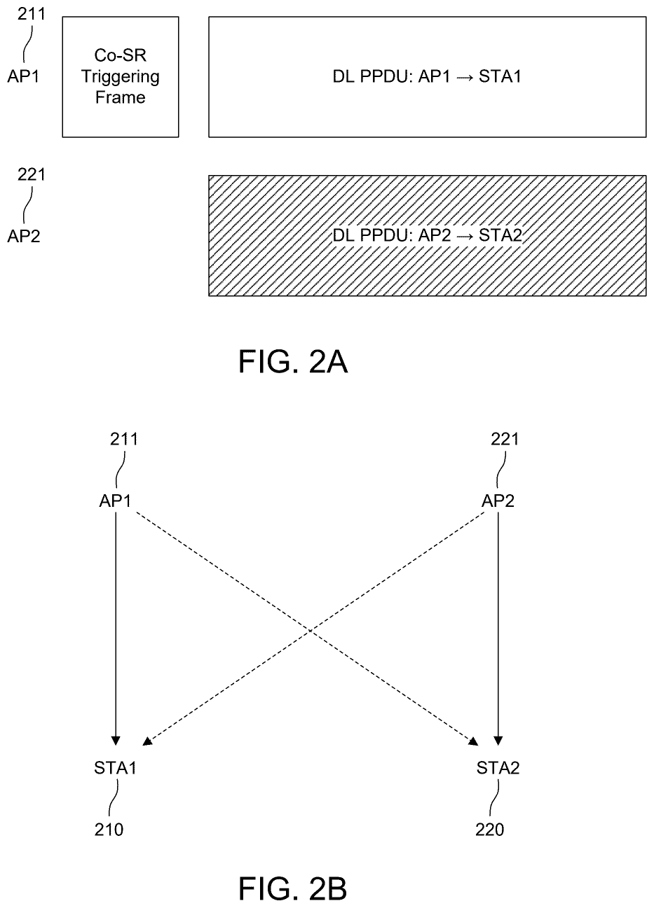

FIG. 2A is a diagram illustrating a transmission opportunity (TXOP) level Co-SR transmission scheme defined by IEEE 802.11bn.

FIG. 2B is a diagram illustrating the signal and interference paths between two concurrent Co-SR downlink data PPDU transmission pairs. In the illustrated examples, a first AP (referred to herein as AP₁) 211 may be a sharing AP transmitting to a first station (referred to herein as STA₁) 210 and a second AP (referred to herein as AP₂) 221 may be a shared AP simultaneously transmitting to a second station (referred to herein as STA₂) 220. In FIG. 2B, transmissions are illustrated as straight lines and interferences are illustrated as dotted lines. For the sake of clarity, embodiments are described herein with the examples of a DL Co-SR data PPDU transmission from AP₁, the sharing AP, to STA₁ as the main data PPDU transmission, and a simultaneous DL data PPDU transmission from AP₂, the shared AP, to STA₂ as the secondary data PPDU transmission. Embodiments described herein are not limited to two simultaneous DL transmissions and are applicable to any number (e.g., greater than two) of simultaneous transmissions of any type (e.g., not limited to DL) between APs and STAs.

In embodiments described herein, “AP₁” and “the sharing AP” may be used interchangeably, “AP₂” and “the shared AP” may be used interchangeably, “STA₁” and “the non-AP STA receiving the DL main Co-SR data PPDU from AP₁” may be used interchangeably, and “STA₂” and “the non-AP STA receiving the DL secondary Co-SR data PPDU from AP₂” may be used interchangeably. In embodiments described herein, more than one shared AP may transmit DL PPDUs during the concurrent Co-SR DL data PPDU transmission. In embodiments described herein, AP(n+1) may refer to the nth shared AP and STA(n+1) may refer to the corresponding recipient of its Co-SR DL PPDU, e.g., AP₃ and STA₃, AP₄ and STA₄, etc.

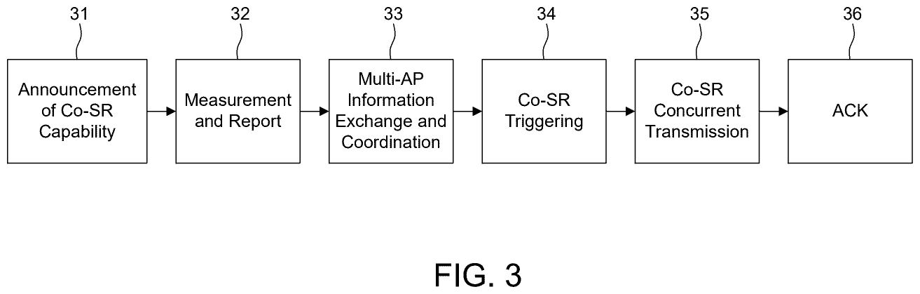

FIG. 3 is a diagram illustrating an example of Co-SR protocol.

In an example, as shown at 31, an AP may announce (e.g., transmit announcement information indicating) any of its Co-SR capabilities and enablement through some elements in management frames such as any of a beacon frame, an action frame, an association response frame, a reassociation response frame, and a probe response frame. As shown at 32, a STA associated with an AP that may enable Co-SR, may listen and measure the receive signal strength indicator (RSSI) and/or path loss from its associated AP and neighboring APs, and may send the measurements to its associated AP. As shown at 33, multiple APs that may be in a multi-AP coordination (MAPC) group for Co-SR may exchange their in-BSS measurement reports and may form coordination decisions based on the pooled measurement reports. As shown at 34, when an AP obtains a TXOP and decides (e.g., determines) to be a sharing AP, it may send out a Co-SR triggering frame to signal (e.g., indicate) one or more other shared APs to transmit data PPDUs in the following Co-SR concurrent transmission slot. As shown at 35, the sharing AP and one or more shared APs may perform concurrent Co-SR transmissions (using the same resources). The shared AP may control the transmit power so that it may be causing tolerable interference to the STA that may be receiving from the sharing AP. The sharing AP may or may not control the transmit power. As shown at 36, the recipient STAs of the data PPDUs may send acknowledgments (ACKs) that may be to be received by their respective APs.

In an example, one or more STAs may measure received power and/or path loss from APs in a multi-AP Co-SR coordination group through beacons or special measurement PPDUs and may report to their respective APs. APs may exchange the measurements within the multi-AP Co-SR coordination group.

In an example, based on the measurements, a sharing AP that may be a TXOP owner may select its own traffic recipient, shared APs that will concurrently transmit OBSS PPDUs and/or their respective traffic recipients, and the power control parameters for shared APs.

In an example, further power control and scheduling information may be exchanged in the TXOP through an initial control frame by the sharing AP and initial response frames by the shared APs.

In an example, the sharing AP may further send a Co-SR trigger frame (e.g., right) before the concurrent Co-SR data PPDUs to further specify (e.g., indicate) any of transmit power and transmit/receiving parameters for the concurrent Co-SR data PPDUs.

In an example, different ACK types or power control may be used for the ACKs to the concurrent Co-SR data PPDUs.

Methods and procedures of measurement and report are described herein.

In embodiments described herein, STAs may measure any of RSSI and path loss from neighboring APs to improve the determination of any of (i) which shared AP may be allowed to transmit concurrently with the main transmission between the sharing AP and its STA, and (ii) at what transmit power level to not cause unacceptable interferences to the main transmission.

For the sake of clarity, embodiments are described herein with the example of transmitting a PPDU to allow associated STAs to perform received power measurements. Embodiments described herein are not limited to PPDUs and any kind of transmission (e.g., referred to as first transmission) allowing a STA to perform measurement may be applicable to embodiments described herein.

For the sake of clarity, embodiments are described herein with the example of measuring an RSSI or a pathloss. In an example, a path loss may be determined as a difference between a first power level (e.g., used at the transmitter) and a second power level (measured at the reception). Embodiments described herein are not limited to RSSI/path loss/signal to noise ratio (SNR), channel quality indicator (CQI) measurements described herein and any kind of received power measurements allowing to determine a tolerance to interferences may be applicable to embodiments described herein.

In embodiments described herein the terms “received power measurement” and “received power measurement information” may be used interchangeably.

For the sake of clarity, embodiments are described herein with the examples sending a report request frame and receiving a report response frame for reporting the measurement results. Embodiments described herein are not limited to report request and report response frames and any kind of first/second frames (such as e.g., power measurement report request/response frames) allowing to report measurements may be applicable to embodiments described herein.

Multi-AP information exchange and coordination is described herein.

To avoid causing (e.g., excessive, unacceptable) interference to an OBSS STA receiving from its associated AP, a shared AP may know the path loss to the OBSS STA and may control the transmit power. This measurement may be performed by the OBSS STA in the measurement and report stage and may be available at the OBSS AP. In an example, the coordinating APs may have a mechanism and procedure to exchange information to obtain the RSSI/pathloss reports by the OBSS STAs.

Signals in triggering frame for Co-SR is described herein.

In Co-SR, the transmit (Tx) power from a (e.g., each) transmitter in BSSs participating in coordinated transmission may be set properly to avoid undesirable inter-BSS interference. Power related information may be included in the triggering frame for Co-SR.

In embodiments described herein the terms “trigger frame”, “triggering frame” and “Co-SR triggering frame” may be used interchangeably.

Co-SR Concurrent Data PPDU Transmission is described herein.

During the concurrent data PPDU transmission, interference mitigation or management specific signaling, e.g., signals to indicate and turn on interference management, may allow to facilitate the proper receiving of the data PPDUs.

For the sake of clarity, embodiments are described herein with the examples of concurrent data PPDU transmission. Embodiments described herein are not limited to data PPDU transmission and any kind of transmissions (e.g., referred to as third/fourth/sixth transmission) to be performed using a same set of resources for spatial reuse may be applicable to embodiments described herein.

Acknowledgement (ACK) is described herein.

The Co-SR concurrent data PPDUs may happen in the DL direction from APs to non-AP STAs. The ACKs to these PPDUs may happen in the reverse UL direction. Non-AP STAs may have a mechanism to control transmit power (e.g., similar to what may be done at the AP side), which may be used to enable concurrent ACKs transmission. Embodiments described herein may also enable mechanisms to stagger ACKs in time/frequency/spatial resources to avoid interference.

For the sake of clarity, embodiments are described herein with one shared AP and one receiving STA as an example. Embodiments described herein are not limited to only one shared AP and one receiving STA. Embodiments described herein are applicable to any number of shared APs and any number of receiving STAs of the Co-SR main or secondary data PPDU transmissions.

Measurement and report are described herein.

In an example, to support Co-SR, APs in the MAPC group may transmit PPDUs any of in a sequential order in time and on different frequency resources, such as any of channels, subchannels, resource units (RUs), multi resource units (MRUs) and distributed resource units (DRUs). In an example, any of the allocation, the order in time and the resource in frequency, of these transmissions may be determined during the formation or the setup of the MAPC group. In another example, the APs may be pre-configured with any of the allocation, the order in time and the resource in frequency to be used to perform these transmissions. Any kind of static/dynamic configuration for configuring resources to perform the measurement and report may be applicable to embodiments described herein. The process of a measurement for Co-SR may be referred to herein as measurement phase.

In the measurement phase, the PPDUs transmitted from APs may carry any of a beacon frame, a MAC frame, and a null data packet (NDP) frame.

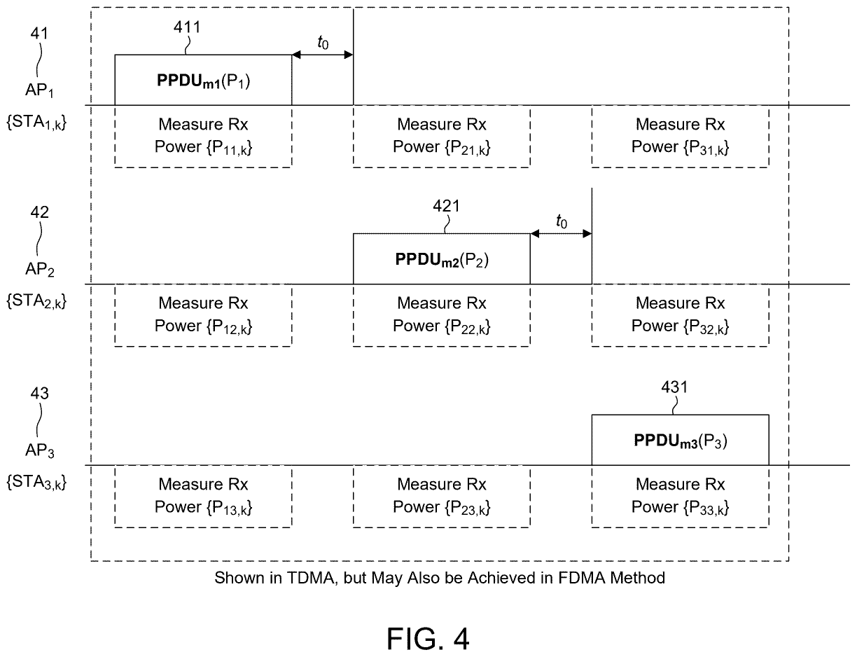

FIG. 4 is a diagram illustrating an example process in the measurement phase assuming three APs participate in Co-SR. In this example, a first AP 41 (referred to as AP₁), a second AP (referred to as AP₂) 42 and a third AP 43 (referred to as AP₃) may respectively transmit a first transmission 411 (referred to as PPDUₘ₁), a second transmission 421 (referred to as PPDUₘ₂), and a third transmission 431 (referred to as PPDUₘ₃), for measurement with a first Tx power (referred to as P₁), a second Tx power (referred to as P₂) and a third Tx power (referred to as P₃), respectively. In this example, those PPDUs 411, 421, 431 are transmitted in a sequential manner with predefined order and the gap (in time) between the transmissions with a predefined duration, to, which may be any of a distributed interframe space (DIFS) and a short interframe space (SIFS). The transmissions of those PPDUs 411, 421, 431 may be over a common channel with a (e.g., certain) bandwidth, or different channels (subchannels or resource units (RUs/MRUs/DRUs)). If they are transmitted on different channels, they may be transmitted concurrently without interfering to each other (not shown in FIG. 4).

Before the measurement phase may start, one or more (e.g., or all) STAs associated with an (e.g., each) AP, which may participate in Co-SR, may be aware of the time of the (e.g., each) PPDU 411, 421, 431 to be transmitted, which may be accomplished, for example during the MAPC group setup (or via a pre-configuration of the STAs). As shown in FIG. 4, a set of STAs (referred to as {STA_{i,k}}) is associated with APᵢ, i=1, 2, 3, where k is the index/ID of those STAs. As shown in FIG. 4, when APᵢ transmits PPDUₘᵢ with Tx power Pᵢ, the STAs associated with APⱼ, j=1, 2, 3, may measure the received power (or RSSI), which may be measured, for example, at the antenna connector in at least one 20 MHz subchannel. The received power (e.g., measurement) corresponding to the transmitted PPDUₘᵢ from APᵢ, at k-th STA associated with j-th AP is referred to as {P_{ij,k}}. At the end of measurement phase, the (e.g., each) STA may obtain three received power measurements, one for each transmission of PPDUₘᵢs. In an example, the measured Rx power may be at per subchannel basis, e.g., for (e.g., each) 20 MHz channel in 80 MHz channel bandwidth. The Rx power measurement may be referred to as {P_{ijn,k}}, for n-th subchannel.

In embodiments described herein a received power measurement may include any of a pathloss measurement, a signal to noise ratio (SNR) measurement, and a channel quality indicator (CQI) measurement.

In another example, the set of transmissions (e.g., PPDUₘᵢ) from APᵢ may not follow a predetermined order or timing and may include normal periodic beacon frames from APs. In this example, the APs may use a predetermined transmit power, e.g., the maximum transmit power, for the beacon frames if they are in an MAPC group for Co-SR. An AP may send information about (e.g., indicating) the participating OBSS APs (e.g., any of their BSSIDs, AP IDs, predetermined transmit power, etc.) to its associated STAs that may participate in the Co-SR measurement phase. The notification may happen, for example, in management frames such as e.g., any of a beacon, an action, an association response, a reassociation response, and a probe response frames. In another example, the notification may happen (e.g., be included) in the report request frame.

A reporting phase may follow a measurement phase.

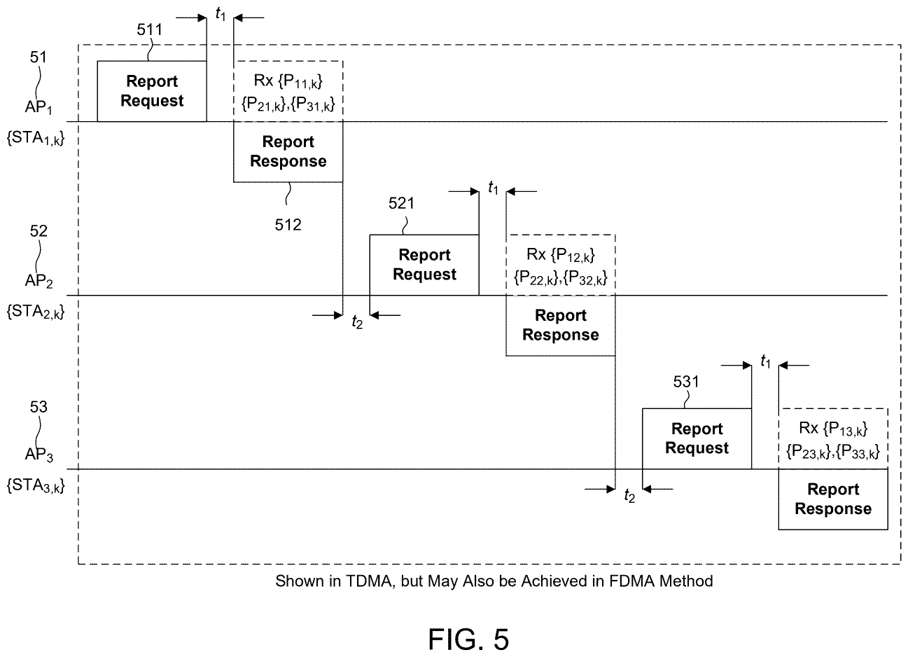

FIG. 5 is a diagram illustrating an example process in the reporting phase. During the reporting phase, a (e.g., each) AP 51, 52, 53 may send a report request frame 511, 521, 531 to its associated STAs which may have participated in measurements during the measurement phase. The report request frame 511, 521, 531 may be implemented using any type of triggering frame, such as e.g., any of a basic trigger frame, a multi-user request to send (MU-RTS) frame, a beamforming report poll (BFRP) frame, etc. The report request may allocate (e.g., indicate) the resources, in any of time and frequency, in the report request frame for the STAs that may respond to the request. In the report response frame, a (e.g., each) STA may send the measurements corresponding to the transmissions of PPDUₘⱼs from different APs. As shown in FIG. 5, the k-th STA, (referred to as STA_{i,k}) associated with APᵢ, may send its measured received powers {P_{ji,k},j=1, 2, 3} to AP₁. If the measured received power is available at per subchannel basis, a (e.g., each) STA may (e.g., also) report its measured received power for (e.g., each of) the subchannels. In an example, the STAs may (e.g., also) send any of path loss, SNR or CQI to their associated APs as their measurements.

Referring to FIG. 4 and FIG. 5, in an example, a first AP 41, 51 may transmit a first transmission 411 (e.g., to be used for measurement), a second AP 42, 52 may transmit a second transmission 421 (e.g., to be used for measurement) and a third AP 43, 53 may transmit a fifth transmission 431 (e.g., to be used for measurement). The first AP 41, 51 may transmit to a first STA associated with the first AP 41, 51, a first frame 511 that may request received power measurement information. In an example, the first AP 41, 51 may receive from the first STA a second frame 512 that may include the requested received power measurement information. In an example, the requested received power measurement information may indicate any of (i) first received power measurement information associated with the first transmission 411 measured at the first STA, (ii) second received power measurement information associated with the second transmission 421 received from a second AP 42, 52 and measured at the first STA, the first STA not being associated with the second AP 42, 52, and (iii) third received power measurement information associated with the fifth transmission 431 received from the third AP 43, 53 and measured at the first STA, the first STA not being associated with the third AP 43, 53.

Multi-AP exchange and coordination is described herein.

Multi-AP information exchange is described herein.

In an example, one AP may address (e.g., transmit) one or more MAPC report request frames to APs in the MAPC group for multi-AP coordination. Similar to the report request frame mentioned above, the MAPC report request frames may be implemented using any type of triggering frame, such as e.g., any of the basic trigger frame, MU-RTS, BFRP, etc. The APs may transmit in the MAPC report response frame the measurement reports they may have collected from their associated STAs or e.g., from other APs. For example, a (e.g., each) AP may have (e.g., in addition to the measurements of its associated STAs to other participating OBSS APs) the measurements of other OBSS STAs to any of the OBSS APs. In the above 3-AP illustrated example, a (e.g., each) AP may collect the measurements {P_{ji,ki}} for i=1, 2, 3, j=1, 2, 3, and kᵢ=1, 2, 3 . . . , Kᵢ, where Kᵢ may refer to the number of Co-SR participating STAs associated with APᵢ. With a complete power or path loss measurement map on (e.g., all) the possible signal and interference paths, the APs and STAs may be able to improve their decisions on the selection of concurrent transmission pairs.

As shown in FIG. 2A, the selected shared AP may encode and transmit the secondary data PPDU in a short interval (e.g., SIFS) after the end of the Co-SR triggering frame. Padding may be included in the triggering frame for the shared AP to finish the data PPDU encoding and generation process. The padding time (e.g., needed) may be exchanged through the above MAPC report response frame.

In an example, the above information exchange may happen at a slower time scale, e.g., once in a (e.g., each) beacon interval or e.g., even longer. In another example, inter-AP information exchange may (e.g., also) happen at a TXOP level with (e.g., only) information relevant to this specific TXOP.

FIG. 6 is a diagram illustrating an example TXOP level MAP information exchange and coordination. As shown in FIG. 6, AP₁ as the TXOP owner and sharing AP, may transmit a Co-SR initial control frame (ICF), which may reuse any of an MU-RTS trigger frame and a buffer status report poll (BSRP) trigger frame, or use a new trigger variant. In the Co-SR ICF 61, AP₁ may poll one or more of the APs in its Co-SR MAPC group to determine which AP may have traffic (e.g., data) queued for transmission, and, for example, to which STA(s) the traffic (e.g., data) may be directed. The sharing AP may (e.g., also) indicate any of STA₁ (e.g., the recipient for its ensuing DL Co-SR data PPDU), the AP₁ transmit power, the acceptable interference level at STA₁, the intended transmission scheme to STA₁ (e.g., any of RU allocation (including DRU and/or regular RU (RRU)), modulation and coding scheme (MCS), forward error correction (FEC) coding (convolutional code, LDPC or 2×LDPC), number of spatial streams, PPDU format (EHT or UHR), interference mitigation on/off, PPDU duration, etc.), and the power or path loss measurement from STA₁ to AP₂, AP₃, and AP₄. The ICF 61 may (e.g., also) allocate (e.g., indicate) the resources, in any of time and frequency, in Co-SR initial response frame (IRF) frame for the APs. As illustrated in FIG. 6, AP₂ and AP₄ may respond 62, 63 in the Co-SR IRF based on the queued traffic and channel conditions and AP₃ may not respond. AP₂ may propose (e.g., indicate) a list of potential STA₂s, their power or path loss measurement to AP₁ (STA₂ to AP₁), and their respective traffic priority. AP4 may do the same with potential STA₄s. AP₂ and AP₄ may (e.g., also) indicate the padding time they may expect (e.g., need) for their Co-SR data PPDU encoding and generation. AP₁ may accommodate (e.g., all) the responding APs or may select (e.g., only) a subset of the responding APs for the Co-SR transmission (e.g., AP₄ is not selected in the example shown in FIG. 6) and set power control parameters for the shared APs following the procedure described here below.

TXOP level selection and power control is described herein.

In an example, after the measurement phase and the reporting phase, an (e.g., each) AP in an MAPC group may have the measured received powers from (e.g., measured at) its associated k-th STAs. For example, if there are three APs in the MAPC group, the i-th AP in an MAPC group may have received the received powers {P_{ji,k},j=1, 2, 3} from the j-th AP measured at its associated k-th STA, referred to as STA_{i,k}, or {P_{ji,kn},j=1, 2, 3} for the n-th subchannel. Using these measured received powers, an (e.g., each) AP may determine the received signal-to-interference-plus-noise-ratio (SINR), or the signal-to-interference-ratio (SIR), and may determine (e.g., choose) the corresponding MCS for the DL transmissions.

In one example, one of the APs in the MAPC group, e.g., AP₁, may obtain the TXOP, and it may allow other APs, e.g., AP₂ and AP₃, in the MAPC group to transmit data during this TXOP with proper transmit powers. This AP may be referred to as any of an initiator AP, a sharing AP, and a first AP. Then, the Co-SR may be performed as described in the following steps.

In a first step, the first AP (AP₁) may determine a set of its associated STAs, {STA₁ₖ, k=1, . . . , K₁}, for DL MU-OFDMA on a set of resource units (RUs) {RUₙ, n=1, . . . , K₁}, where K₁ may refer to the number of STAs in the set. In an example, there may be (e.g., only) one station in the set.

In a second step, the first AP (AP₁) may compute the received SINRs for (e.g., each of) those STAs in the set and (e.g., each) RUs, say, {SINR_{1,kn}, k=1, . . . , K₁, n=1, . . . , K₁}, where

$$S I N {R}_{1 , k n} = \frac{{P}_{11 , kn}}{{P}_{21 , kn} + {P}_{31 , kn} + {N}_{k n}}$$

(k being referred to as the index of the STAs, and n being referred to as the index of RU), Nₖₙ may refer to the noise power for STAₖ at RUₙ. If the interference is more dominant than noise, SINR_{1,kn} may be approximated by the signal-to-interference-ratio

$$S I {R}_{1 , k n} = \frac{{P}_{11 , k n}}{{P}_{21 , k n} + {P}_{31 , k n}} .$$

The same may be applicable to any SINR values described herein.

In a third step, the first AP (AP₁) may assign an RU to (e.g., each of) the STAs in the STA set, e.g., RU_{1,nk} for STA₁ₖ. The assignment may be done based on different criteria, such as e.g., data size or/and QoS or/and throughput requirement. Given the RU allocation and the corresponding performance criteria, a set of desired SINRs,

$$\{ S I N {R}_{1 , k}^{desired} \}$$

for the STAs may be determined.

In a fourth step, if the received SINR for STA₁ₖ on RU_{1,nk} satisfies one or more conditions

$$( e . g . , if S I N {R}_{1 , k {n}_{k}} \geq S I N {R}_{1 , k}^{desired} ) ,$$

the first AP (AP₁) may not (e.g., need to) request other APs to reduce their transmit power on RU_{1,nk}. If the received SINR for STAₖ fails to satisfy the one or more conditions

$$( e . g . , S I N {R}_{1 , k {n}_{k}} < S I N {R}_{1 , k}^{desired} ) ,$$

the first AP (AP₁) may (e.g., need to) request other APs to adjust (e.g., reduce) their transmit power on RU_{1,nk}, or may prohibit/disallow other APs to transmit on RU_{1,nk}. In an example, the first AP (AP₁) may request the second AP (AP₂) to adjust (e.g., reduce) its transmit power on RU_{1,nk} by a first transmit power adjustment (referred to as AP_{2,n}_{ₖ}) and may request the third AP (AP₃) to adjust (e.g., reduce) its transmit power on RU_{1,nk} by a second transmit power adjustment (referred to as AP_{3,n}_{ₖ}), such that:

$$S I N {R}_{1 , k {n}_{k}} = \frac{{P}_{11 , {kn}_{k}}}{{P}_{21 , k {n}_{k}} - Δ {P}_{2 , {n}_{k}} + {P}_{31 , {kn}_{k}} - Δ {P}_{3 , {n}_{k}} + {N}_{k {n}_{k}}} \geq S I N {R}_{1 , k}^{desired}$$

For example, the first AP (AP₁) may determine any of the first transmit power adjustment (e.g., AP_{2,n}_{ₖ}) for the second AP and the second transmit power adjustment (e.g., AP_{3,n}_{ₖ}) for the third AP based on a function (e.g., an SINR) of any of the first received power measurement, the second received power measurement and the third received power measurement failing to satisfy the one or more conditions.

For example, the first AP (AP₁) may determine adjusted second received power measurement based on the second received power measurement and the first transmit power adjustment for the second AP. Similarly, the first AP (AP₁) may determine adjusted third received power measurement based on the third received power measurement and the second transmit power adjustment for the third AP. For example, determining the first transmit power adjustment (e.g., and the second transmit power adjustment) may comprise determining the first transmit power adjustment (e.g., and the second transmit power adjustment) based on the function (e.g., SINR) of the first received power measurement and the adjusted second received power measurement (e.g., and the adjusted third received power measurement information) satisfying the one or more conditions.

In another example, the first transmit power adjustment may be a first ratio (referred to as 0≤α_{2,n}_{ₖ}≤1) and the second transmit power adjustment may be a second ratio (referred to as 0≤α_{3,n}_{ₖ}≤1). The first AP may request the second AP to adjust (e.g., reduce) its transmit power based on applying the first ratio and may request the third AP to adjust (e.g., reduce) its transmit power based on applying the second ratio, such that:

$$S I N {R}_{1 , k {n}_{k}} = \frac{{P}_{11 , {kn}_{k}}}{{a}_{2 , {n}_{k}} {P}_{21 , {kn}_{k}} {α}_{3 , {n}_{k}} {P}_{31 , k {n}_{k}} + {N}_{k {n}_{k}}} \geq S I N {R}_{1 , k}^{desired}$$

In an example, the first AP may determine any of the first and the second transmit power adjustment (ΔP_{2,n}_{ₖ} and ΔP_{3,n}_{ₖ} (or α_{2,n}_{ₖ} and α_{3,n}_{ₖ})) based on its knowledge about the traffic requirements of other BSSs. In another example, the first AP may determine the first and the second transmit power adjustment being similar (ΔP_{2,n}_{ₖ}=ΔP_{3,n}_{ₖ} (or α_{2,n}_{ₖ}=α_{3,n}_{ₖ}). In addition, the first AP may use a trigger frame, which may trigger starting of Co-SR transmissions, to send the required transmit power adjustment (ΔP_{2,n}_{ₖ} and ΔP_{3,n}_{ₖ} (or α_{2,n}_{ₖ} and α_{3,n}_{ₖ})) and their corresponding RU, RU_{1,n}_{ₖ}, to other APs in the MAPC group.

In an example, α_{2,n}_{ₖ}=0 or α_{3,n}_{ₖ}=0 may mean that spatial reuse for AP₂ or AP₃ may not be allowed, respectively.

In a fifth step, after the second AP and the third AP may have received their respective transmit power adjustment (ΔP_{2,n}_{ₖ} and ΔP_{3,n}_{ₖ} (or α_{2,n}_{ₖ} and α_{3,n}_{ₖ})) and their corresponding RU, RU_{1,n}_{ₖ}, they may compute the SINRs after the power adjustments requested by the first AP.

In a first example, if RU_{1,n}_{ₖ}=∪ₙ_{ₖ}, RU_{2,n}_{ₖ}, and RU_{1,n}_{ₖ}=∪ₙ_{ₖ}, RU_{3,n}_{ₖ}, e.g., an RU allocated for STA₁ₖ associated with AP₁ may include multiple RUs allocated for multiple STAs associated with the second AP and the third AP,

$$S I N {R}_{2 , {k}^{′} {n}_{{k}^{′}}} = \frac{{P}_{22 , {k}^{′} {n}_{{k}^{′}}} − Δ {P}_{2 , {n}_{k}}}{{P}_{12 , {k}^{′} {n}_{{k}^{′}}} + {P}_{32 , {k}^{′} {n}_{{k}^{′}}} − Δ {P}_{3 , {n}_{k}} + {N}_{{k}^{′} {n}_{{k}^{′}}}}$$

$$and$$

$$S I N {R}_{3 , {k}^{′} {n}_{{k}^{′}}} = \frac{{P}_{33 , {k}^{′} {n}_{{k}^{′}}} − Δ {P}_{3 , {n}_{k}}}{{P}_{13 , {k}^{′} {n}_{{k}^{′}}} + {P}_{23 , {k}^{′} {n}_{{k}^{′}} − Δ {P}_{2 , {n}_{k}}} + {N}_{{k}^{′} {n}_{{k}^{′}}}}$$

$$or$$

$$S I N {R}_{2 , {k}^{′} {n}_{{k}^{′}}} = \frac{{α}_{2 , {n}_{k}} {P}_{22 , {k}^{′} {n}_{{k}^{′}}}}{{P}_{12 , {k}^{′} {n}_{{k}^{′}}} + {α}_{3 , {n}_{k}} {P}_{32 , {k}^{′} {n}_{{k}^{′}}} + {N}_{{k}^{′} {n}_{{k}^{′}}}}$$

$$and$$

$$S I N {R}_{3 , {k}^{′} {n}_{{k}^{′}}} = \frac{{α}_{3 , {n}_{k}} {P}_{33 , {k}^{′} {n}_{{k}^{′}}}}{{P}_{13 , {k}^{′} {n}_{{k}^{′}}} + {α}_{2 , {n}_{k}} {P}_{23 , {k}^{′} {n}_{{k}^{′}}} + {N}_{{k}^{′} {n}_{{k}^{′}}}}$$

In this first example, the second AP and the third AP may choose the MCSs (e.g., for each of them) based on computed SINR_{2,k′n}_{_{k′}} and SINR_{3,k′n}_{_{k′}}, respectively.

In a second example, If ∪ₙ_{ₖ} RU_{1,n}_{ₖ}=RU_{2,n}_{_{k′}} and ∪ₙ_{ₖ} RU_{1,n}_{ₖ}=RU_{3,n}_{_{k′}}, e.g., an RU allocated for STA_{k′} associated with the second AP and an RU allocated for STA_{k′} associated with the third AP may include multiple RUs allocated for multiple STAs associated with the first AP,

$$S I N {R}_{2 , {k}^{′} {n}_{{k}^{′}}} = \frac{{P}_{22 , {k}^{′} {n}_{{k}^{′}}} − {max}_{{n}_{k}} Δ {P}_{2 , {n}_{k}}}{{P}_{12 , {k}^{′} {n}_{{k}^{′}}} + {P}_{32 , {k}^{′} {n}_{{k}^{′}}} - {min}_{{n}_{k}} Δ {P}_{3 , {n}_{k}} + {N}_{{k}^{′} {n}_{{k}^{′}}}}$$

$$and$$

$$S I N {R}_{3 , {k}^{′} {n}_{{k}^{′}}} = \frac{{P}_{33 , {k}^{′} {n}_{{k}^{′}}} − {max}_{k} Δ {P}_{3 , {n}_{k}}}{{P}_{13 , {k}^{′} {n}_{{k}^{′}}} + {P}_{23 , {k}^{′} {n}_{{k}^{′}} - {min}_{{n}_{k}} Δ {P}_{2 , {n}_{k}} + {N}_{{k}^{′} {n}_{{k}^{′}}}}}$$

$$or$$

$$S I N {R}_{2 , {k}^{′} {n}_{{k}^{′}}} = \frac{( {min}_{{n}_{k}} {α}_{2 , {n}_{k}} ) {P}_{22 , {k}^{′} {n}_{{k}^{′}}}}{{P}_{12 , {k}^{′} {n}_{{k}^{′}}} + ( {max}_{{n}_{k}} {α}_{3 , {n}_{k}} ) {P}_{32 , {k}^{′} {n}_{{k}^{′}} + {N}_{{k}^{′} {n}_{{k}^{′}}}}}$$

$$and$$

$$S I N {R}_{3 , {k}^{′} {n}_{{k}^{′}}} = \frac{( {min}_{{n}_{k}} {α}_{3 , {n}_{k}} ) {P}_{33 , {k}^{′} {n}_{{k}^{′}}}}{{P}_{13 , {k}^{′} {n}_{{k}^{′}}} + ( {max}_{{n}_{k}} {α}_{2 , {n}_{k}} ) {P}_{23 , {k}^{′} {n}_{{k}^{′}}} + {N}_{{k}^{′} {n}_{{k}^{′}}}}$$

In this second example, the second AP and the third AP may choose the MCSs (e.g., for each of them) based on computed SINR_{2,k′n}_{ₖ}, and SINR_{3,k′n}_{_{k′}}, respectively.

In a third example, If RU_{1,n}_{ₖ}=∪ₙ_{_{k′}}RU_{l,n}_{_{k′}} and ∪ₙ_{ₖ} RU_{1,n}_{ₖ}=RU_{m,n}_{_{k′}} where l,m=2 or 3 and l≠m, e.g., an RU allocated for STA₁ₖ associated with the first AP includes multiple RUs allocated for multiple STAs associated with APₗ and an RU allocated for STA_{k′} associated with APₘ includes multiple RUs allocated for multiple STAs associated with the first AP,

$$S I N {R}_{l , {k}^{′} {n}_{{k}^{′}}} = \frac{{P}_{ll , {k}^{′} {n}_{{k}^{′}}} - Δ {P}_{l , {n}_{k}}}{{P}_{1 l , {k}^{′} {n}_{{k}^{′}}} + {P}_{m , l , {k}^{′} {n}_{{k}^{′}}} - Δ {P}_{m , {n}_{k}} + {N}_{{k}^{′} {n}_{{k}^{′}}}}$$

$$and$$

$$S I N {R}_{m , {k}^{′} {n}_{{k}^{′}}} = \frac{{P}_{mm , {k}^{′} {n}_{{k}^{′}}} − {max}_{{n}_{k}} Δ {P}_{m , {n}_{k}}}{{P}_{1 m , {k}^{′} {n}_{{k}^{′}}} + {P}_{lm , {k}^{′} {n}_{{k}^{′}}} − {min}_{{n}_{k}} Δ {P}_{m , {n}_{k}} + {N}_{{k}^{′} {n}_{{k}^{′}}}}$$

$$or$$

$$S I N {R}_{l , {k}^{′} {n}_{{k}^{′}}} = \frac{{α}_{l , {n}_{k}} {P}_{ll , {k}^{′} {n}_{{k}^{′}}}}{{P}_{1 l , {k}^{′} {n}_{{k}^{′}}} + {α}_{m , {n}_{k}} {P}_{ml , {k}^{′} {n}_{{k}^{′}}} + {N}_{{k}^{′} {n}_{{k}^{′}}}}$$

$$and$$

$$S I N {R}_{m , {k}^{′} {n}_{{k}^{′}}} = \frac{( {min}_{{n}_{k}} {α}_{m , {n}_{k}} ) {P}_{mm , {k}^{′} {n}_{{k}^{′}}}}{{P}_{1 m , {k}^{′} {n}_{{k}^{′}}} + ( {max}_{{n}_{k}} {α}_{l , {n}_{k}} ) {P}_{lm , {k}^{′} {n}_{{k}^{′}} {N}_{{k}^{′} {n}_{{k}^{′}}}}}$$

In this third example, APₗ and APₘ may choose the MCSs (e.g., for each of them) based on computed SINR_{l,k′n}_{_{k′}} and SINR_{m,k′n}_{_{k′}}, respectively, where l,m=2 or 3 and l≠m.

In an example, the values of α_{l,n}_{ₖ} and α_{m,n}_{ₖ}, in the typical range of [0, 1], may be represented by a set of bits, for (e.g., each of) the l, m, and k values. In one or more examples, the power adjustment parameters α's may go above 1 and ΔP's may go below zero so that the shared APs may be able to boost their transmit power and still keeping their interference to the sharing AP's transmission below an allowable/tolerable level.

In the above-described examples, the first AP, being the TXOP holder, may be a dominator in choosing its MCS, and the transmit power of other APs are power controlled to avoid strong interference to the first AP's associated STA. In some other examples, the dominator in choosing the MCS may not be the TXOP holder. A negotiation phase may be included between the report phase and data transmission phase, in which a dominator may be determined.

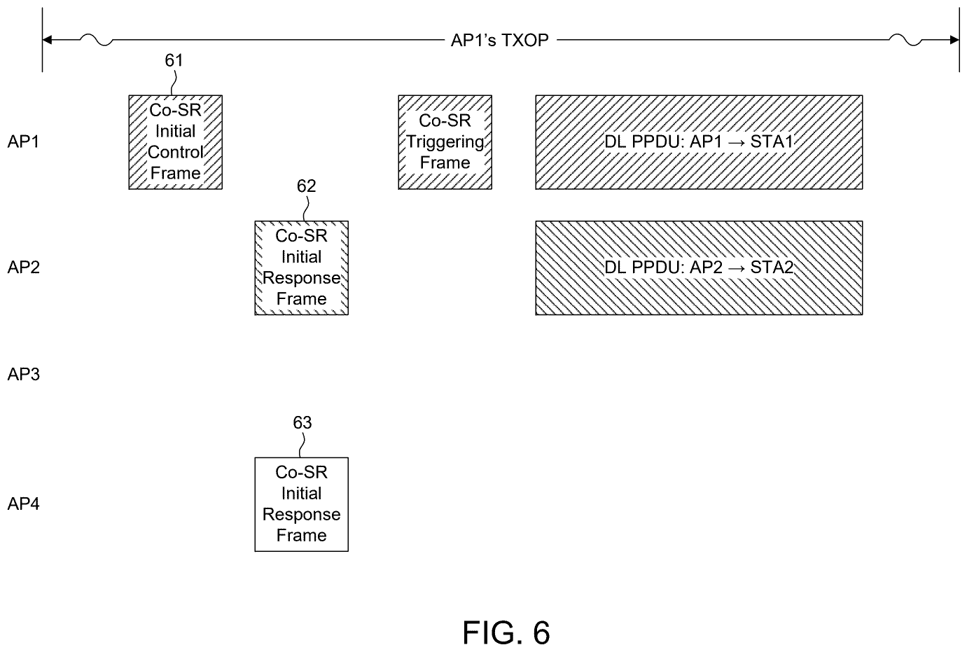

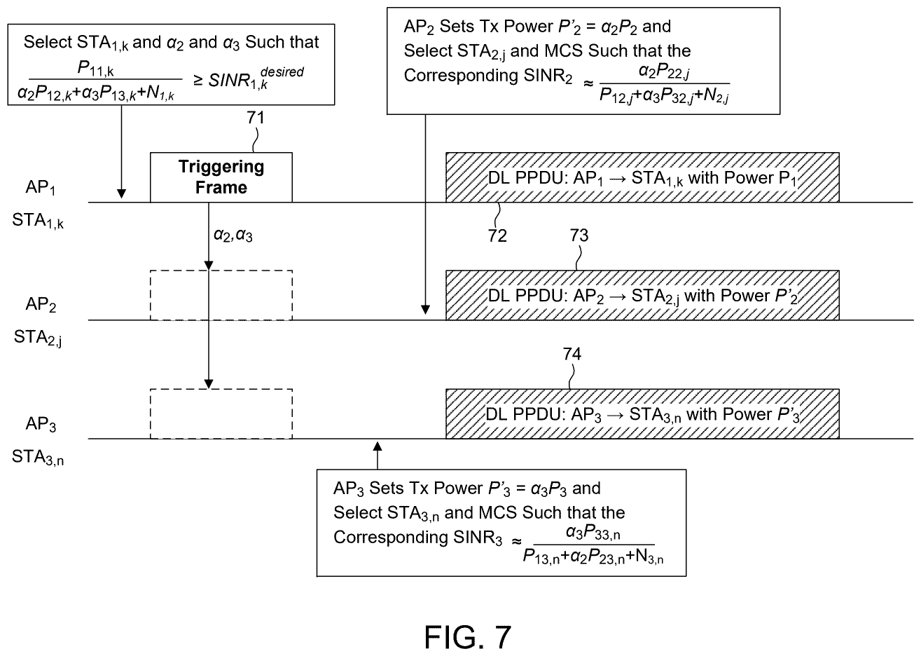

FIG. 7 is a diagram illustrating an example of Co-SR with power control. In the illustrated example, the three APs in the MAPC group use the same RU to transmit data (e.g., perform concurrent transmissions) to their associated stations.

As shown at FIG. 7, the first AP may transmit (e.g., to the second AP and the third AP) a trigger frame 71 that may include a second AP identifier (e.g., identifying the second AP), a third AP identifier (e.g., identifying the third AP), a first indication of first transmit power adjustment information (e.g., ΔP_{2,n}_{ₖ}, α₂) for the second AP, and a second indication of second transmit power adjustment information (e.g., ΔP_{3,n}_{ₖ}, α₃) for the third AP based on any of the indicated first, second and third received power measurement information.

As shown at FIG. 7, the first AP may transmit to the first STA a third transmission 72 that may share a same set of resources as the second AP used for a fourth transmission 73 and as the third AP used for a sixth transmission 74. In an example, transmitting the third transmission 72 over the same set of resources as the second AP for the fourth transmission 73 and as the third AP for the sixth transmission 74 may be based on any of the first transmit power adjustment information for the second AP and the second transmit power adjustment information for the third AP.

For the sake of clarity, embodiments are described herein with SINR/SIR as example functions of received power measurements and adjusted received power measurements. Embodiments described herein are not limited to the described SINR/SIR. Any function of received power measurements and adjusted received power measurements allowing to determine whether a condition (relative to an acceptable level of interferences) is satisfied may be applicable to embodiments described herein.

In embodiments described herein the terms “adjusted first/second received power measurement” and “adjusted first/second received power measurement information” may be used interchangeably. In embodiments described herein the terms “first/second transmit power adjustment” and “first/second transmit power adjustment information” may be used interchangeably.

A Co-SR triggering frame is described herein.

In an example, the sharing AP (AP₁) may transmit a Co-SR triggering frame before transmitting the concurrent Co-SR data PPDU. The triggering frame may contain (e.g., indicate) any of (i) a first basic service set (BSS) color associated with the first AP, (ii) a second BSS color associated with the second AP, (iii) a group identifier identifying a multi-AP coordination group to which the first AP and the second AP belong, (iv) a first STA identifier identifying the first STA, (v) one or more second STA identifiers identifying one or more suggested second STAs for receiving the fourth transmission from the second AP, (vi) an acceptable interference level at the first STA to decode the third transmission, (vii) an acceptable interference level at the first AP to decode an acknowledgement to the third transmission from the first STA, (viii) a modulation and coding scheme (MCS) to be used for the third transmission, (ix) a path loss between the first STA and the second AP, (x) one or more types of acknowledgements to any of the third and fourth transmissions, (xi) punctured channel information associated with any of the third and fourth transmissions, (xii) a coordinated spatial reuse transmission mode, (xiii) a time interval between the trigger frame and any of the third transmission and the fourth transmission, and (xiv) a duration of any of the fourth transmission and the third transmission.

The triggering frame may further contain (e.g., indicate) the second AP identifier, identifying the second AP.

The triggering frame may further contain (e.g., indicate) any of (i) a third BSS color associated with the third AP, (ii) the third AP identifier (e.g., identifying the third AP), (iii) one or more third STA identifiers identifying one or more suggested third STAs for receiving the sixth transmission from the third AP, and (iv) a path loss between the first STA and the third AP.

The triggering frame may contain (e.g., indicate) an (e.g., first) AP identifier (ID) of the sharing AP (AP₁). The (e.g., first) AP ID may indicate the sharing AP that may initiate and set up the Co-SR operation. The AP ID of the APs participating in MAPC may be a universal value that may (e.g., uniquely) identify an AP (at least among the set of its neighboring APs) regardless (e.g., independently) of the MAPC group that this AP may belong to. The AP ID may comprise a relative index that may identify an AP within an MAPC group that it may belong to.

The triggering frame may contain (e.g., indicate) one or more AP IDs of the one or more shared APs (AP₂, AP₃, . . . ). There may be (e.g., only) one selected AP₂ as expected by IEEE 802.11bn, or multiple shared APs. The one or more AP IDs may indicate the shared AP(s) that may be allowed to transmit in the ensuing concurrent Co-SR data PPDU transmission. The SINR and power adjustment calculation and analysis in the TXOP level selection and power control description above may serve as a basis for the selection of the shared AP(s). The selection of the shared AP(s) may be based on its path loss to the sharing AP's intended receiver STA₁ satisfying a condition (e.g., the path loss may be large enough so that the interference from AP₂ at STA₁ may be tolerable). In another example, another indicator of the interference from AP₂ to STA₁, (e.g., the RSSI of AP₂ at STA₁) may satisfy a condition (e.g., be small enough, lower than a threshold). The selection of the shared AP may (e.g., also) depend on additional traffic information exchanged in the multi-AP exchange and coordination stage. For example, AP₂ may be selected with priority if it indicated that it may expect or may have ongoing low-latency traffic. If multiple shared APs are allowed, their combined interference level at STA₁ may satisfy a condition (e.g., be lower than a tolerable level). In another example, if STA₁ can learn AP₂ through this parameter, based on the pathloss information, STA₁ may be able to perform power control on the ACK it may send to AP₁ so that it may cause tolerable interference at AP₂ receiving an ACK from STA₂ at the same time.

The triggering frame may contain (e.g., indicate) a (e.g., first) BSS color of the sharing AP's residing BSS. This may be used as an extra identification of the sharing AP.

The triggering frame may contain (e.g., indicate) a (e.g., second) BSS color of the shared AP's residing BSS. This may be used as an extra identification of the shared AP.

The triggering frame may contain (e.g., indicate) a (e.g., MAPC) group ID. An (e.g., MAPC) group ID may be used to identify the MAPC group that AP₁ and AP2 may belong to. The MAPC group may have more APs other than AP₁ and AP₂. If the AP ID of an AP is a relative index within an MAPC group it may belong to, the AP ID plus the MAPC group ID may (e.g., uniquely) identify the AP from its neighboring APs. In an example, the MAPC group ID may allow to reduce AP ID collision and may facilitate the early termination and power save of those APs/STAs that may not belong to the identified MAPC group.

The triggering frame may contain (e.g., indicate) a (e.g., first) STA₁ ID. This may indicate the receiving STA of the main data PPDU transmission from the sharing AP. There may be one STA₁ as expected in IEEE 802.11bn, or multiple STA₁s receiving the main data PPDU. Based on decoding the Co-SR triggering frame, the shared AP may know to which STA it may be causing interference, e.g., STA₁. The shared AP may control the transmit power of the secondary data PPDU transmission based on the path loss/RSSI information it may have obtained from the multi-AP exchange and coordination stage on STA₁ such that the interference level at (e.g., each) STA₁ may satisfy a condition (may be below an acceptable level).

The triggering frame may contain (e.g., indicate) one or more (e.g., a list of suggested/second) STA₂ IDs. This may allow the sharing AP to suggest the potential receiving STAs of the secondary data PPDU transmission to the shared AP. Based on the path loss/RSSI information that may have been obtained from the multi-AP exchange and coordination stage (through TXOP level ICF/IRF or request/response frames in slower time scale) on OBSS STAs, the sharing AP may suggest those OBSS STAs that may have larger path loss or smaller RSSI with the sharing AP to the shared AP. For example, STA₂ may cause tolerable interference to the sharing AP when later simultaneously (e.g., concurrently) STA₁ may transmit an ACK to AP₁ (the sharing AP) and STA₂ may transmit an ACK to AP₂ (the shared AP). For example, this may (e.g., also) enable that the sharing AP of the main data PPDU transmission may be causing smaller interference to the receiver of the secondary data PPDU transmission. The shared AP may or may not pick STA₂ from the list if there is no traffic demand for STA₂ in the list and/or there is higher traffic priority for a STA₂ outside of the list.

The triggering frame may contain (e.g., indicate) an AP₁ transmit power. This may indicate the transmit power used by the sharing AP, AP₁, in the main data PPDU transmission. It may be an absolute value of the transmit power in use, or a delta value being the difference between the transmit power in use and a reference power such as a known/preselected (e.g., maximum) transmit power of the sharing AP, or a ratio relevant to the reference power. Based on this information, the shared AP may calculate the interference from AP₁ to its potential receivers, may select a STA₂ based on the interference and other selection criteria such as any of traffic priority and load, and may select a proper transmission scheme (e.g., any of a number of spatial streams, an MCS, an equal or unequal modulation (UEQM), interference mitigation on/off, DRU or RRU allocation, FEC coding, etc.) for the transmission to STA₂ based on any of the interference and channel conditions. The AP₁ Tx power may be indicated for a (e.g., each) 20 MHz channel, e.g., the AP₁ Tx power may be indicated as a set of (e.g., different values) for different 20 MHz channels, or the AP₁ Tx power may be indicated as a (e.g., single value) for the whole bandwidth.

The triggering frame may contain (e.g., indicate) an AP₂ transmit power (such as e.g., first transmit power adjustment information). This may indicate the upper bound (e.g., maximum) transmit power or a suggested power to be used by AP₂, the shared AP, in its secondary data PPDU transmission. Similar to the AP₁ transmit power parameter, it may be an absolute value, or a delta value relevant to a reference power such as the current AP₂ Tx power level or a known (e.g., maximum) Tx power level, or a ratio relevant to the reference power. The sharing AP may set this value based on the tolerable interference level at its receiver STA₁, determined based on any of its own transmit power, the intended transmission scheme (MCS, etc.) to STA₁, the RSSI/path loss information from AP₂ to STA₁, etc. The AP₂ transmit power may be specified for a (e.g., each) 20 MHz channel.

The triggering frame may contain (e.g., indicate) a tolerable (e.g., maximum) interference level at STA₁. This may indicate the (e.g., maximum) interference level acceptable at STA₁ so that STA₁ may still successfully decode the main data PPDU transmission from the sharing AP. The tolerable (e.g., maximum) interference level at STA₁ may be specified for a (e.g., each) 20 MHz channel. If there are multiple STA₁s, this value may take the lowest (e.g., minimum) of (e.g., all) the (e.g., maximum) interference levels allowable at a (e.g., each) STA₁.

The triggering frame may contain (e.g., indicate) a tolerable (e.g., maximum) interference level at AP₁ for receiving an acknowledgment (ACK). This may indicate the (e.g., maximum) interference level acceptable at AP₁ such that AP₁ may still successfully decode the ACK from STA₁ responding to the main data PPDU transmission. The (e.g., maximum) interference level at AP₁ may be indicated for a (e.g., each) 20 MHz channel.

The triggering frame may contain (e.g., indicate) an MCS to be used in the main data PPDU transmission from AP₁ to STA₁. This information may be used by the shared AP to determine the acceptable interference level at STA₁ and e.g., add a margin on top.

The triggering frame may contain (e.g., indicate) an STA₁ to AP₂ path loss and/or interference. This may allow AP₂, the shared AP, to decide on what is the desirable ACK scheme from STA₂ to AP₂ that may follow the secondary data PPDU transmission from AP₂ to STA₂. If the STA₁ to AP₂ interference level is high, AP₂ may avoid receiving an ACK from STA₂ while STA₁ may be transmitting an ACK to AP₁ at the same time, by any of specifying no ACK from STA₂, and resorting to a block ack procedure where STA₂ may send an ACK later upon the request of AP₂.

The triggering frame may contain (e.g., indicate) one or more types of acknowledgments (ACK). The sharing AP may indicate its intended ACK scheme/type for the main data PPDU transmission. The ACK scheme/type may be any of no ACK, normal ACK, and delayed block ACK. Based on the ACK scheme/type for the main data PPDU and the interference levels from STA₁ to AP₂, and/or from STA₂ to AP₁, the shared AP may determine the ACK scheme for its secondary data PPDU and may signal (e.g., indicate) this scheme to its recipient STA₂ in the secondary data PPDU. In another example, the sharing AP may explicitly indicate the ACK types for (e.g., both) the main data PPDU and the secondary data PPDU. In an example, the shared AP may signal/indicate the ACK type in the secondary data PPDU to its recipient STA₂.

The triggering frame may contain punctured channel information. The sharing AP may indicate the punctured 20 MHz subchannels for its main PPDU transmission and may (e.g., also) indicate the disallowed 20 MHz subchannels for the secondary PPDU transmissions.

The triggering frame may contain (e.g., indicate) a Co-SR transmission mode. AP₁, the sharing AP, may indicate the Co-SR transmission mode to be used for the Co-SR concurrent transmission, whether it may be Mode 2 where (e.g., all) the concurrent data PPDUs may be UHR PPDUs, or Mode 1 where at least one of the concurrent data PPDUs may be an EHT PPDU.

The triggering frame may contain (e.g., indicate) a time interval between the end of the Co-SR triggering frame and the start of any of the ensuing concurrent data PPDUs. This parameter may be used to prepare the shared AP to start transmitting the secondary data PPDU at the correct time. It may be (e.g., implied to be) SIFS if the Co-SR transmission mode is Mode 2 with (e.g., both) UHR PPDUs. When explicitly stated as a parameter, it may indicate the number of SIFS, or an absolute time value.

The triggering frame may contain (e.g., indicate) a data PPDU duration. This may indicate the duration or length of any of the concurrent data PPDUs. The shared AP may ensure that its data PPDU has the correct duration e.g., as indicated. If the data PPDU has a shorter duration, the shared AP may apply some type of padding to align the end of the data PPDUs.

The triggering frame may contain (e.g., indicate) any of a start and an end time of the concurrent data PPDUs. This may enable an alternative method for the shared AP and sharing AP to align the concurrent data PPDUs in time.

In embodiments described herein, one or more of the parameters described to be included in the trigger frame (such as e.g., the AP/STA/MAP IDs and interference/pathloss related parameters), may also be applicable to any of the frames in the measurement and report stage, and/or the ICF/IRF in the TXOP level MAP information exchange and coordination stage. The format and bits assignment described herein provide example ways to carry the parameters mentioned above. Any other format and bits assignment may be applicable to embodiments described herein.

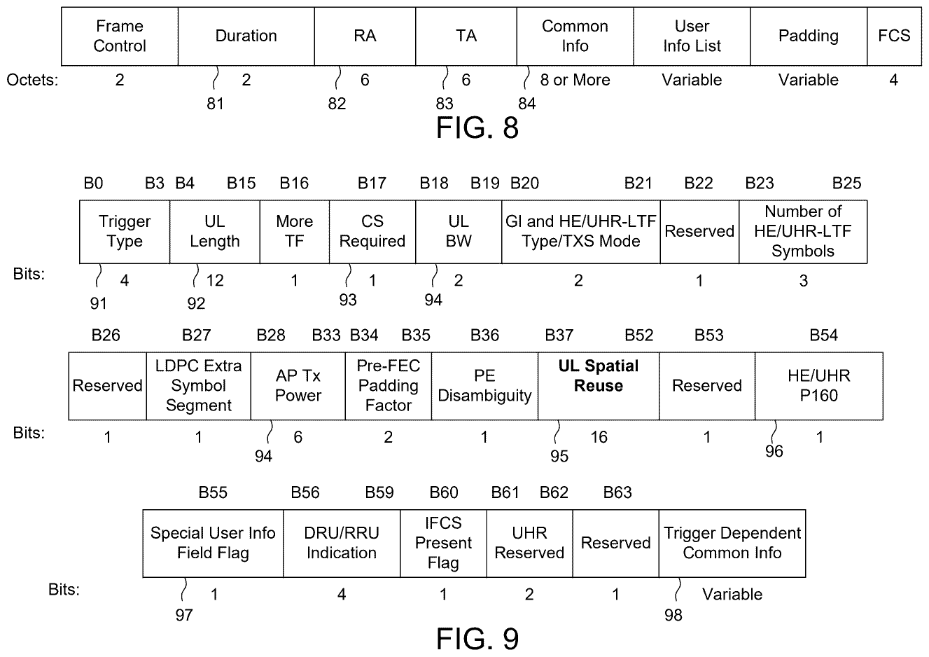

FIG. 8 is a diagram illustrating an example trigger frame format. The trigger frame may serve as the Co-SR triggering frame to carry the parameters described above.

The Duration field 81 may be set to a network allocation vector (NAV) value that may protect up to the end of the concurrent data PPDUs plus the ACKs sent back to the sharing and shared APs. The NAV value may be accurate to microsecond if the ACK types are predetermined by the sharing AP, or an estimate if the ACK type for the secondary data PPDU is determined by the shared AP later.

The receiver address or receiving station address (RA) field 82 may be set to any of (i) a broadcast address, (ii) the MAPC group ID of the sharing AP and shared AP(s), (iii) the AP ID of the shared AP, and (iv) a combination of the MAPC group ID and the AP ID of the shared AP.

The transmitter address or transmitting station address (TA) field 83 may include any of the MAC address of the sharing AP, the AP ID of the sharing AP, and the combination of the MAPC group ID and the AP ID of the sharing AP.

The Common Info field 84 may have a UHR variant Common Info field format as shown in FIG. 9, where “UL” may be changed to “DL” or “UL/DL”.

FIG. 9 is a diagram illustrating an example UHR variant Common Info field.

The Trigger Type subfield 91 may be set to 3 to reuse the MU-RTS trigger frame variant, or 4 to reuse the buffer status report poll (BSRP) trigger frame variant, or an integer value in the range of 9 to 15 to define a new trigger frame variant for the Co-SR triggering frame referred to as, e.g., the Co-SR trigger frame variant. The UL/DL Length subfield 92 may be set to indicate the value of the L-SIG LENGTH field of the ensuing Co-SR data PPDUs. The carrier sense (CS) Required subfield 93 may be set to zero to indicate that the shared AP(s) may not (e.g., needs to) perform clear channel assessment (CCA) and may transmit the ensuing data PPDU after a specified time interval from the end of the trigger frame. The AP Tx Power subfield 94 may indicate the sharing AP's combined transmit power at the transmit antenna connector of (e.g., all) the antennas used to transmit the ensuing data PPDU from AP₁ to STA₁ e.g., in units of dBm/20 MHz, e.g., the aforementioned AP₁ transmit power parameter. In an example, the UL/DL Spatial Reuse field 95 may be set to zero to indicate the parameterized spatial reuse (PSR)-based spatial reuse operation defined in IEEE P802.11-REVme™/D7.0 may be disallowed. In another example, the UL/DL Spatial Reuse field 95 may be repurposed as a DL Spatial Reuse field that may indicate the tolerable interference power level at STA₁, e.g., the acceptable (e.g., maximum) interference level at STA₁ parameter. The tolerable/acceptable interference power level at STA₁ may be indicated directly in units of dBm/20 MHz through the bits in the DL Spatial Reuse field, or by mapping the bits in the DL Spatial Reuse field to a power level through a predefined bits-to-power-level table. The HE/UHR P160 subfield may be repurposed as a Co-SR Mode field to indicate the acceptable Co-SR transmission mode (zero for Mode 1, or one for Mode 2, or vice versa) for the ensuing Co-SR data PPDUs. In an example, a reserved bit, e.g., B53 shown at FIG. 9, may be used as a Co-SR Mode field, and the HE/UHR P160 subfield 96 may (e.g., only) indicate the Co-SR data PPDU type of the one from AP₁ to STA₁, e.g., zero for UHR and one for non-UHR or EHT. The Special User Info Field Flag subfield 97 may be set to zero to indicate that a Special User Info field may be included (e.g., immediately) after the Common Info field. In an example, the Trigger Dependent Common Info subfield 98 may not be present for the Co-SR trigger frame variant. In another example, the Trigger Dependent Common Info subfield 98 may be 12-bit long and may indicate the STA_ID of STA₁ to signal (e.g., indicate) the recipient of the sharing AP's main data PPDU transmission. The Trigger Dependent Common Info field 98 of the Co-SR trigger frame variant may (e.g., also) include bits to indicate the time interval between the end of the Co-SR triggering frame, e.g., zero for one SIFS, one for two SIFSs, and so on. The Trigger Dependent Common Info field 98 of the Co-SR trigger frame variant may (e.g., also) have bits assigned to indicate the ACK types of the main and/or secondary data PPDU transmission, for example, including additional subchannel information if the ACKs are to be staggered in the frequency domain. The acceptable (e.g., maximum) interference level at AP₁ for receiving an ACK from STA₁ may (e.g., also) be included here.

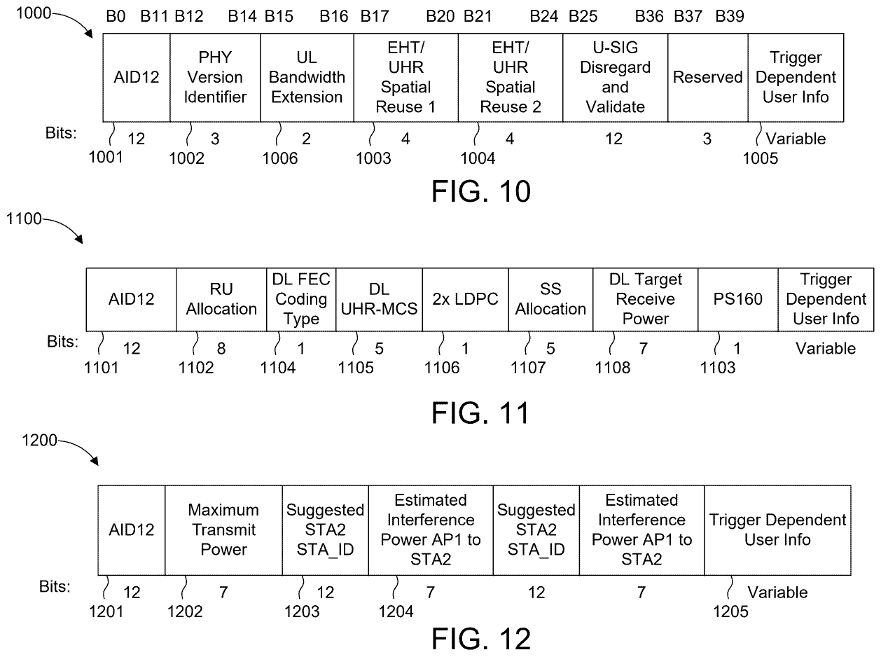

FIG. 10 is a diagram illustrating an example Special User Info field format.

The User Info List field may start with a Special User Info field 1000 as shown in FIG. 10. The Special User Info field 1000 may be identified by a value of 2007 in the AID12 subfield 1001. The PHY Version Identifier subfield 1002 may be used to indicate the PHY version of the solicited ensuing data PPDU from the shared AP(s): e.g., one for UHR, zero for don't care (e.g., any of EHT or UHR may be acceptable). The PHY Version Identifier subfield 1002 may be used to indicate the Co-SR mode: e.g., zero for Mode 1, one for Mode 2, or vice versa. The PHY Version Identifier subfield 1002 may be used to indicate the data PPDU type from the sharing AP: e.g., one for UHR, zero for EHT. The two EHT/UHR Spatial Reuse 1 and 2 subfields 1003, 1004 may be reused to indicate the tolerable interference power level per 20 MHz at STA₁. In an example, the Trigger Dependent User Info subfield 1005 may not be present for the Co-SR Trigger frame variant. In another example, the Trigger Dependent User Info subfield 1005 may be 12-bit long and may indicate the identifier of STA₁ (e.g., STA_ID) to signal (e.g., indicate) the recipient of the sharing AP's main data PPDU transmission. Any information subfields mentioned for the Trigger Dependent Common Info field of the Co-SR trigger frame variant may be placed (e.g., included) in the Trigger Dependent User Info subfield 1005.

Multiple UHR variant User Info fields may follow the Special User Info field.

FIG. 11 is a diagram illustrating a first UHR variant User Info field format for Co-SR main data PPDUs. The first UHR variant User Info field 1100 for Co-SR may provide more information on the DL main data PPDU from AP₁ to STA₁. In an example, the AID12 subfield 1101 may be set to the sharing AP's AP ID. In another example, the AID12 subfield 1101 may be set to the identifier of STA₁ (e.g., STA_ID). The RU Allocation subfield 1102 along with the UL BW subfield 94 in the Common Info field, the UL BW Extension subfield 1006 in the Special User Info field 1000, and the PS160 subfield 1103 in the UHR variant User Info field 1100, may identify the size and location of any of an RU and MRU (including RRU and/or DRU) used for the DL main data PPDU from AP₁ to STA₁. The DL forward error correction (FEC) Coding Type subfield 1104 may indicate if the DL main data PPDU from AP₁ to STA₁ may be using low-density parity-check (LDPC) or binary convolutional codes (BCC). The DL UHR-MCS subfield 1105 may indicate any of the MCS index (if equal modulation) and the largest MCS index (if unequal modulation) used in the DL main data PPDU from AP₁ to STA₁. The 2×LDPC subfield 1106 may indicate if the nominal LDPC codeword length of 3888 may be used. The spatial stream (SS) Allocation subfield 1107 may indicate if equal modulation or unequal modulation may be used, and the number of spatial streams if equal modulation is used, or the unequal modulation pattern if unequal modulation is used. The DL Target Receive Power subfield 1108 may indicate the received power level of the data PPDU transmission from AP₁ at STA₁.

FIG. 12 is a diagram illustrating a second UHR variant User Info field format for Co-SR main data PPDUs. The second UHR variant User Info field 1200 for Co-SR may contain more information on the DL secondary data PPDU from the shared AP to its recipient. The AID12 field 1201 in this case may be set to the AP ID of the shared AP. The Maximum Transmit Power subfield 1202 may indicate the allowed maximum transmit power e.g., in the unit of dBm/20 MHz by the shared AP. The Suggested STA₂ STA_ID field 1203 may indicate the suggested recipient of the secondary data PPDU from the shared AP. In an example, the Estimated Interference Power AP₁ to STA₂ subfield 1204 may indicate the interference power STA₂ may receive from the sharing AP when the sharing AP is using the transmit power indicated in the AP TX Power subfield 94 indicated in the UHR variant Common Info field. In another example, the Estimated Interference Power AP₁ to STA₂ subfield 1204 may indicate the path loss from AP₁ to STA₂. The sharing AP may suggest more than one STA₂ to AP₂, the shared AP. In an example, based on traffic priority, the shared AP may select one from the suggested STA₂ list and may set up the secondary data transmission with more complete interference information. In another example, the shared AP may discard (e.g., ignore) the sharing AP's suggestion. In an example, the Trigger Dependent User Info subfield 1205 may not be present. In another example, the Trigger Dependent User Info subfield 1205 may contain (e.g., indicate) an ACK type indicated by AP₁ for a (e.g., each) potential STA₂.

The padding field may be present in the Co-SR triggering frame to give the shared AP (e.g., enough) time to prepare for the secondary data PPDU transmission that may start one or more SIFSs after the end of the Co-SR triggering frame. During the preparation time, the shared AP may select a STA₂ based on any of the traffic priority and the interference information it may have received from the Co-SR triggering frame (or from a previous ICF if present), such as e.g., any of AP₁ transmit power, upper bound (e.g., maximum) allowed transmit power of AP₂, the acceptable (e.g., maximum) interference level at STA₁, RU allocation of the main data PPDU from AP₁ to STA₁, etc. The shared AP may determine (e.g., decide) the transmission scheme to STA₂ (such as e.g., any of the RU allocation, the MCS, the number of spatial streams, equal modulation or unequal modulation, etc.), and may generate the PPDU accordingly. The information about preparation time (e.g., needed) may have been obtained during the multi-AP Co-SR setup or information exchange stage (e.g., through the MAP report request/response frames or the TXOP level Co-SR ICF/IRF), and the padding field may be calculated and set accordingly.

To align the ensuing Co-SR data PPDUs in time and frequency, the shared AP may perform carrier frequency offset correction to bring the frequency difference from the sharing AP under a (e.g., certain) limit through the Co-SR triggering frame. Symbol clock frequency synchronization and correction may (e.g., also) be done through calibrating against the triggering frame.

Co-SR concurrent data PPDU transmissions are described herein.

From the end of the Co-SR triggering frame, after an (e.g., certain) interval that may be indicated in the triggering frame or agreed/shared beforehand among the sharing and shared APs, the sharing AP and shared AP may (e.g., simultaneously, concurrently) start to transmit the data PPDUs (e.g., at the same time, using a same set of resources). The sharing AP may set the transmit power according to, for example, the AP TX Power subfield indicated in the UHR variant Common Info field of the Co-SR triggering frame. The shared AP may set the transmit power below the Maximum Transmit Power level indicated for AP₂, e.g., in the UHR variant User Info field format for Co-SR secondary data PPDUs. The length field of the L-SIG of (e.g., both) the main and secondary data PPDUs may be set to be the same as the UL/DL length subfield indicated in, e.g., the UHR variant Common Info field of the Co-SR triggering frame. The rate field of the L-SIG may be set to the value representing 6 Mb/s in 20 MHz channel spacing. If one of the data PPDUs is an EHT PPDU, the U-SIG of (e.g., both) PPDUs may not be the same. If the data PPDUs are (e.g., both) UHR PPDUs, the U-SIG of (e.g., both) PPDUs may or may not be the same. If U-SIG is the same for enhanced protection of the Co-SR transmissions since the superposed U-SIG signal from (e.g., both) AP₁ and AP₂ may be decoded by STAs in a larger area, the fields may be set as described in IEEE P802.11bn™/D0.1. In this case, the Punctured Channel Information subfield may be the same and may be derived from the RU allocation information set by the sharing AP in the Co-SR triggering frame. Based on (e.g., both) the data PPDUs starting and ending at the same time, any of pre-FEC PHY padding, post-FEC PHY padding, and the packet extension (PE) may be adjusted to meet the requirement.

If the data PPDU is a UHR PPDU, to assist the non-AP STAs deal with interference from other concurrent transmissions, the AP may further turn on an interference mitigation (IM) feature, where a fixed number of IM pilots may be allocated in an (e.g., each) OFDM data symbol for interference estimation and mitigation. This may be signaled (e.g., indicated) in the UHR-SIG preamble, where bits may exist to indicate other new advanced IEEE 802.11bn features such as UEQM, 2×LDPC, etc.

Acknowledgement is described herein.

In one example, a non-AP STA that may receive a Co-SR data PPDU may follow the immediate acknowledgement procedure to transmit any of an ACK and a block ACK frame after a SIFS from the end of the Co-SR data PPDUs. STA₁ may control its transmit power to meet a targeted received power level at AP₁ based on any of the RSSI and path loss measurement. By lowering the transmit power, STA₁ may cause reduced (e.g., minimal) interference to AP₂. In an example, STA₂ may control the transmit power so that its interference level at AP₁ may be lower than a predetermined value or an acceptable value indicated in the Co-SR triggering frame e.g., if STA₂ decodes the triggering frame. For example, the ACK frames may (e.g., also) perform spatial reuse through the power control of the non-AP STAs. If (e.g., both) AP₁ and STA₁ are extended long range (ELR) capable, STA₁ may be able to further lower the transmit power on ACK if it is transmitting an ELR ACK. The same may apply to the STA₂-to-AP₂ ACK. The non-AP STAs may (e.g., also) perform beamforming to respective in-BSS APs to reduce (e.g., minimize) the interference to OBSS APs. The non-AP STAs may (e.g., also) behave as multi-users in a MU-MIMO transmission. For example, STA₁ may occupy the first one or few spatial streams and STA₂ may occupy the next one or few spatial streams. The APs may demodulate (e.g., all) spatial streams and (e.g., only) decode the spatial streams sent by (e.g., received from) their associated STAs. In this example, the STAs may perform frequency and symbol clock correction to their respective APs in expectation that the frequency and clock differences between them may be kept low enough for the MU-MIMO transmission.

In another example, the ACKs for the Co-SR data PPDUs may be staggered in time. For example, after a Co-SR transmission, there may be an immediate ACK from STA₁ to AP₁ for the main data PPDU and there may be no ACK or delayed ACK through any of the block ack request (BAR) and block ack (BA) sequence between STA₂ and AP₂ for the secondary data PPDUs. Or vice versa. The APs may set the ACK policy accordingly in the QoS control subfield of the MAC header of the DL data frames. Any of the normal ACK and implicit BAR policies may dictate an acknowledge frame following the data frame after a SIFS. The block ack policy may wait till receiving a BAR to send out the BA. If the DL data PPDU is a UHR PPDU, the non-AP STA may (e.g., also) be able to infer whether it is receiving a Co-SR main or secondary data PPDU by looking at the Co-SR indication bit in U-SIG and whether its BSS color is the same as the BSS Color 1 (main) or the BSS Color 2 (secondary) in U-SIG, and may follow the predetermined ack policy for any of the main and secondary data PPDUs.

In yet another example, the ACKs for the Co-SR data PPDUs may be sent at the same time (e.g., SIFS after the data PPDUs) and staggered in frequency. In one example, the ACK to the main Co-SR data PPDU may be sent in one 20 MHz subchannel and the ACK to the secondary Co-SR data PPDU may be sent in another 20 MHz subchannel. The assignment may be agreed or announced beforehand, or the assignment may be set in the Co-SR triggering frame, and the no-AP STAs may decode the information. If the DL data PPDU is a UHR PPDU, as described above, the non-AP STA may be able to infer from the U-SIG whether it is receiving the main or secondary Co-SR data PPDU and may select the (e.g., correct) subchannel for its ACK. The STAs may perform frequency and symbol clock correction to their respective APs to keep the frequency and clock differences between them low enough to reduce (e.g., minimize) the inter-channel interference.

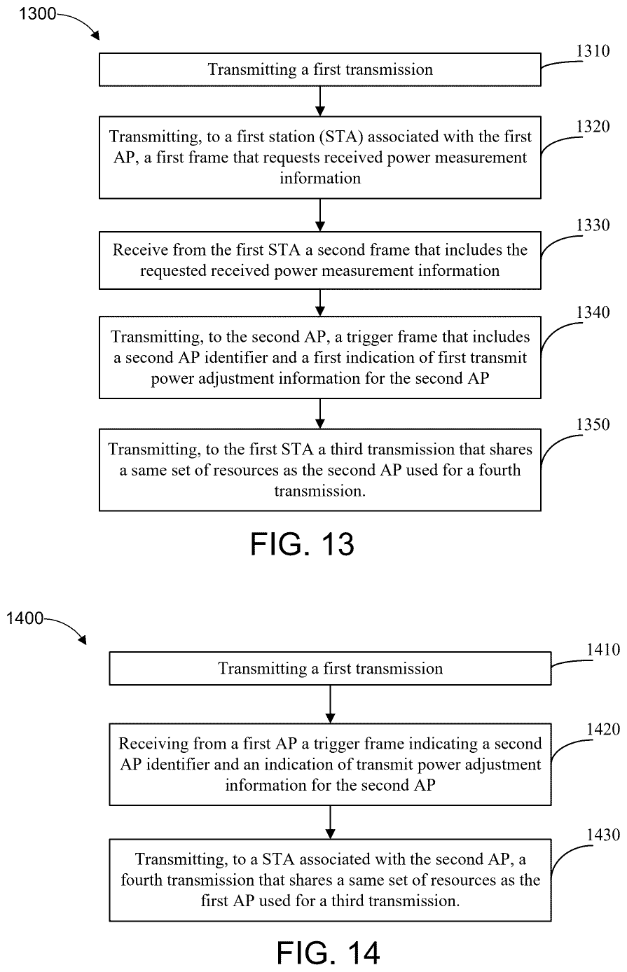

FIG. 13 is a diagram illustrating an example first method 1300 for coordinated spatial reuse transmissions, implemented in a first AP. The first AP may include circuitry including a transmitter, a receiver, a processor, and memory. The circuitry may be configured to carry out the first method 1300. As shown at 1310, the first method 1300 may include transmitting a first transmission (e.g., to be used for measurement). As shown at 1320, the first method 1300 may include transmitting to a first station (STA) associated with the first AP, a first frame that may request received power measurement information. As shown at 1330, the first method 1300 may include receiving from the first STA a second frame including the requested received power measurement information. In various embodiments, the requested received power measurement information may indicate: (i) first received power measurement information associated with the first transmission measured at the first STA, and (ii) second received power measurement information associated with a second transmission received from a second AP and measured at the first STA, the first STA not being associated with the second AP. As shown at 1340, the first method 1300 may include transmitting to the second AP, a trigger frame including a second AP identifier and a first indication of first transmit power adjustment information for the second AP based on the indicated first and second received power measurement information. In various embodiments, the second AP identifier may identify the second AP. As shown at 1350, the first method 1300 may include transmitting to the first STA a third transmission that may share a same set of resources as the second AP used for a fourth transmission. In various embodiments, the first AP transmitting the third transmission over the same set of resources as the second AP used for the fourth transmission may be based on the first transmit power adjustment information for the second AP.

In various embodiments, the first method 1300 may include determining the first transmit power adjustment information for the second AP based on a function of the first received power measurement information and the second received power measurement information failing to satisfy one or more conditions.

In various embodiments, the first method 1300 may include determining adjusted second received power measurement information based on the second received power measurement information and the first transmit power adjustment information for the second AP. In various embodiments, determining the first transmit power adjustment information may comprise determining the first transmit power adjustment information based on the function of the first received power measurement information and the adjusted second received power measurement information satisfying the one or more conditions.

In various embodiments, the function may be based on any of a signal-to-interference-plus-noise-ratio (SINR) and a signal-to-interference-ratio (SIR).

In various embodiments, the requested received power measurement information may further indicate third received power measurement information associated with a fifth transmission received from a third AP and measured at the first STA, the first STA not being associated with the third AP.

In various embodiments, the trigger frame may further indicate a third AP identifier and a second indication of second transmit power adjustment information for the third AP. In various embodiments, the third AP identifier may identify the third AP.

In various embodiments, the first method 1300 may include determining any of the first transmit power adjustment information for the second AP and the second transmit power adjustment information for the third AP based on a function of the first received power measurement information, the second received power measurement information and the third received power measurement information failing to satisfy one or more conditions.

In various embodiments, the first method 1300 may include determining adjusted third received power measurement information based on the third received power measurement information and the second transmit power adjustment information for the third AP. In various embodiments, determining the second transmit power adjustment information may comprise determining the second transmit power adjustment information based on the function of the first received power measurement information, the adjusted second received power measurement information and the adjusted third received power measurement information satisfying the one or more conditions.

In various embodiments, the third transmission may be transmitted in the same set of resources as the third AP used for a sixth transmission.

In various embodiments, the first AP transmitting the third transmission over the same set of resources as the second AP used for the fourth transmission and the third AP used for the sixth transmission may be based on the first transmit power adjustment information for the second AP and the second transmit power adjustment information for the third AP.

In various embodiments, the first transmit power adjustment information and the second transmit power adjustment information may comprise transmit power reductions.

In various embodiments, the first transmit power adjustment information may comprise a transmit power reduction. In various embodiments, the second transmit power adjustment information may comprise a transmit power increase.

In various embodiments, the trigger frame may further indicate any of (i) a first basic service set (BSS) color associated with the first AP, (ii) a second BSS color associated with the second AP, (iii) a group identifier identifying a multi-AP coordination group to which the first AP and the second AP belong, (iv) a first STA identifier identifying the first STA, (v) one or more second STA identifiers identifying one or more suggested second STAs for receiving the fourth transmission from the second AP, (vi) an acceptable interference level at the first STA to decode the third transmission, (vii) an acceptable interference level at the first AP to decode an acknowledgement to the third transmission from the first STA, (viii) a modulation and coding scheme (MCS) to be used for the third transmission, (ix) a path loss between the first STA and the second AP, (x) one or more types of acknowledgements to any of the third and fourth transmissions, (xi) punctured channel information associated with any of the third and fourth transmissions, (xii) a coordinated spatial reuse transmission mode, (xiii) a time interval between the trigger frame and any of the third transmission and the fourth transmission, and (xiv) a duration of any of the fourth transmission and the third transmission.

In various embodiments, the trigger frame may further indicate any of (i) a third BSS color associated with the third AP, (ii) the third AP identifier, and (iii) one or more third STA identifiers identifying one or more suggested third STAs for receiving the sixth transmission from the third AP.

In various embodiments, the first method 1300 may further include transmitting a control frame to any of the second AP and the third AP. In various embodiments, the control frame may be used to poll whether any of the second AP and the third AP have data to be transmitted.

In various embodiments, the first method 1300 may further include receiving from the second AP a third frame indicating one or more candidate second STAs and one or more corresponding second received power measurement information associated with the first transmission and measured at the one or more candidate second STAs.

In various embodiments, the first method 1300 may further include receiving from the third AP a fourth frame indicating one or more candidate third STAs and one or more corresponding third received power measurement information associated with the first transmission and measured at the one or more candidate third STAs.

In various embodiments, the requested received power measurement information may include any of a receive signal strength indicator (RSSI) measurement, a path loss measurement, signal to noise ratio (SNR) measurement, and a channel quality indicator (CQI) measurement.

In various embodiments, the first frame may comprise a power measurement report request frame. In various embodiments, the second frame may comprise a power measurement report response frame.

In various embodiments, the trigger frame may comprise any of a coordinated spatial reuse triggering frame, a multi-user request to send (MU-RTS) frame, and a buffer status report poll (BSRP) frame.

In various embodiments, any of the third transmission, the fourth transmission, and the sixth transmission may comprise a data PPDU transmission.

FIG. 14 is a diagram illustrating an example second method 1400 for coordinated spatial reuse transmissions, implemented in a second AP. The second AP may include circuitry including a transmitter, a receiver, a processor, and memory. The circuitry may be configured to carry out the second method 1400. As shown at 1410, the second method 1400 may include transmitting a first transmission (e.g., to be used for measurement). As shown at 1420, the second method 1400 may include receiving from a first AP a trigger frame indicating a second AP identifier and an indication of transmit power adjustment information for the second AP. In various embodiments, the indication of transmit power adjustment information may be based on the first transmission. In various embodiments, the second AP identifier may identify the second AP. As shown at 1430, the second method 1400 may include transmitting to a STA associated with the second AP, a fourth transmission that may share a same set of resources as the first AP used for a third transmission. In various embodiments, the second AP transmitting the fourth transmission over the same set of resources as the first AP used for the third transmission may be based on the transmit power adjustment information for the second AP.

Any variant described in relation to the first method 1300 implemented in the first AP and illustrated at FIG. 13 may also be applicable to the second method 1400 implemented in the second AP and illustrated at FIG. 14.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and memory, the circuitry being operable (e.g., configured) to process the disclosed method, with a computer program product comprising program code instructions and with a non-transitory computer-readable storage medium storing program instructions. Besides, any characteristic, variant or embodiment described for an AP is compatible with a non-AP STA.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

The content of each of the following references is incorporated by reference herein in its entirety:
IEEE Std 802.11™-2020: Part 11: Wireless LAN Medium Access Control (MAC) and Physical Layer (PHY) Specifications, December 2020, 149 pages.
Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 1: Enhancements for High Efficiency WLAN, IEEE P802.11ax/D8.0 (October 2020), 820 pages
Draft IEEE Standard for Information technology—Telecommunications and information exchange between systems Local and metropolitan area networks—Specific requirements, “Part 11: Wireless LAN Medium Access Control (MAC) and Physical Layer (PHY) Specifications”, IEEE P802.11-REVme™/D7.0, August 2024, 6213 pages
Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 2: Enhancements for extremely high throughput (EHT),” IEEE P802.11be™/D7.0 (August 2024)
YU, “Specification Framework for TGbn,” IEEE 802.11-24/0209r8, January 2025, 58 pages.
Draft Standard for Information technology—Telecommunications and information exchange between systems Local and metropolitan area networks—Specific requirements; “Part 11: Wireless LAN Medium Access Control (MAC) and Physical Layer (PHY) Specifications; Amendment 6: Enhancements for ultra-high reliability (UHR)”, IEEE P802.11bn™/D0.1, January 2025, 240 pages

1. A first access point (AP) comprising circuitry, including a transmitter, a receiver, a processor, and memory, configured to:
transmit a first transmission;
transmit, to a first station (STA) associated with the first AP, a first frame that requests received power measurement information;
receive from the first STA a second frame that includes the requested received power measurement information, wherein the requested received power measurement information indicates: (i) first received power measurement information associated with the first transmission measured at the first STA, and (ii) second received power measurement information associated with a second transmission received from a second AP and measured at the first STA, wherein the first STA is not associated with the second AP;
transmit, to the second AP, a trigger frame that includes a second AP identifier and a first indication of first transmit power adjustment information for the second AP based on the indicated first and second received power measurement information, wherein the second AP identifier identifies the second AP; and
transmit, to the first STA a third transmission that shares a same set of resources as the second AP used for a fourth transmission, wherein transmitting the third transmission over the same set of resources as the second AP used for the fourth transmission is based on the first transmit power adjustment information for the second AP.

2. The first AP of claim 1, further configured to determine the first transmit power adjustment information for the second AP based on a function of the first received power measurement information and the second received power measurement information failing to satisfy one or more conditions.

3. The first AP of claim 2, further configured to determine adjusted second received power measurement information based on the second received power measurement information and the first transmit power adjustment information for the second AP, wherein being configured to determine the first transmit power adjustment information comprises being configured to determine the first transmit power adjustment information based on the function of the first received power measurement information and the adjusted second received power measurement information satisfying the one or more conditions.

4. The first AP of claim 2, wherein the function is based on any of a signal-to-interference-plus-noise-ratio (SINR) and a signal-to-interference ratio (SIR).

5. The first AP of claim 1, wherein the requested received power measurement information further indicates third received power measurement information associated with a fifth transmission received from a third AP and measured at the first STA, wherein the first STA is not associated with the third AP.

6. The first AP of claim 5, wherein the trigger frame further indicates a third AP identifier and a second indication of second transmit power adjustment information for the third AP, wherein the third AP identifier identifies the third AP.

7. The first AP of claim 6, wherein the third transmission is transmitted in the same set of resources as the third AP used for a sixth transmission.

8. The first AP of claim 7, wherein transmitting the third transmission over the same set of resources as the second AP used for the fourth transmission and the third AP used for the sixth transmission is based on the first transmit power adjustment information for the second AP and the second transmit power adjustment information for the third AP.

9. The first AP of claim 6, wherein the first transmit power adjustment information and the second transmit power adjustment information comprise transmit power reductions.

10. The first AP of claim 6, wherein the first transmit power adjustment information comprises a transmit power reduction, and wherein the second transmit power adjustment information comprises a transmit power increase.

11. The first AP of claim 1, wherein the trigger frame further indicates any of (i) a first basic service set (BSS) color associated with the first AP, (ii) a second BSS color associated with the second AP, (iii) a group identifier identifying a multi-AP coordination group to which the first AP and the second AP belong, (iv) a first STA identifier identifying the first STA, (v) one or more second STA identifiers identifying one or more suggested second STAs for receiving the fourth transmission from the second AP, (vi) an acceptable interference level at the first STA to decode the third transmission, (vii) an acceptable interference level at the first AP to decode an acknowledgement to the third transmission from the first STA, (viii) a modulation and coding scheme (MCS) to be used for the third transmission, (ix) a path loss between the first STA and the second AP, (x) one or more types of acknowledgements to any of the third and fourth transmissions, (xi) punctured channel information associated with any of the third and fourth transmissions, (xii) a coordinated spatial reuse transmission mode, (xiii) a time interval between the trigger frame and any of the third transmission and the fourth transmission, and (xiv) a duration of any of the fourth transmission and the third transmission.

12. The first AP of claim 7, wherein the trigger frame further indicates any of (i) a third BSS color associated with the third AP, (ii) the third AP identifier, and (iii) one or more third STA identifiers identifying one or more suggested third STAs for receiving the sixth transmission from the third AP.

13. The first AP of claim 5, further configured to transmit a control frame to any of the second AP and the third AP, wherein the control frame is used to poll whether any of the second AP and the third AP have data to be transmitted.

14. The first AP of claim 1, further configured to receive from the second AP a third frame indicating one or more candidate second STAs and one or more corresponding second received power measurement information associated with the first transmission and measured at the one or more candidate second STAs.

15. The first AP of claim 6, further configured to receive from the third AP a fourth frame indicating one or more candidate third STAs and one or more corresponding third received power measurement information associated with the first transmission and measured at the one or more candidate third STAs.

16. The first AP of claim 1, wherein the requested received power measurement information includes any of a receive signal strength indicator (RSSI) measurement, a path loss measurement, signal to noise ratio (SNR) measurement, and a channel quality indicator (CQI) measurement.

17. The first AP of claim 1, wherein the first frame comprises a power measurement report request frame, wherein the second frame comprises a power measurement report response frame, and wherein the trigger frame comprises any of a coordinated spatial reuse triggering frame, a multi-user request to send (MU-RTS) frame, and a buffer status report poll (BSRP) frame.

18. The first AP of claim 7, wherein any of the third transmission, the fourth transmission, and the sixth transmission comprise a data PPDU transmission.

19. A method implemented in a first access point (AP), comprising:
transmitting a first transmission;
transmitting, to a first station (STA) associated with the first AP, a first frame that requests received power measurement information;
receiving from the first STA a second frame that includes the requested received power measurement information, wherein the requested received power measurement information indicates: (i) first received power measurement information associated with the first transmission measured at the first STA, and (ii) second received power measurement information associated with a second transmission received from a second AP and measured at the first STA, wherein the first STA is not associated with the second AP;
transmitting, to the second AP, a trigger frame that includes a second AP identifier and a first indication of first transmit power adjustment information for the second AP based on the indicated first and second received power measurement information, wherein the second AP identifier identifies the second AP; and
transmitting, to the first STA a third transmission that shares a same set of resources as the second AP used for a fourth transmission, wherein transmitting the third transmission over the same set of resources as the second AP used for the fourth transmission is based on the first transmit power adjustment information for the second AP.

20. A second access point (AP) comprising circuitry, including a transmitter, a receiver, a processor, and memory, configured to:
transmit a first transmission;
receive from a first AP a trigger frame indicating a second AP identifier and an indication of transmit power adjustment information for the second AP, wherein the indication of transmit power adjustment information is based on the first transmission and wherein the second AP identifier identifies the second AP; and
transmit, to a STA associated with the second AP, a fourth transmission that shares a same set of resources as the first AP used for a third transmission, wherein transmitting the fourth transmission over the same set of resources as the first AP used for the third transmission is based on the transmit power adjustment information for the second AP.
